(19) United States
(12) Patent Application Publication
(10) Pub. No.: US 2013/0014022 A1
(43) Pub. Date: Jan. 10, 2013

(54) NETWORK SYSTEM, COMMUNICATION METHOD, AND COMMUNICATION TERMINAL

(75) Inventors: Masahide Takasugi, Osaka-shi (JP); Masaki Yamamoto, Osaka-shi (JP); Misuzu Kawamura, Osaka-shi (JP)

(73) Assignee: SHARP KABUSHIKI KAISHA, Osaka-shi, Osaka (JP)

(21) Appl. No.: 13/638,022

(22) PCT Filed: Mar. 8, 2011
(86) PCT No.: PCT/JP2011/055382

§ 371 Date: Sep. 28, 2012

(30) Foreign Application Priority Data
Mar. 30, 2010 (JP) 2010-077782

(51) Int. Cl. G06F 3/048; G06F 3/041

(52) U.S. Cl. 715/748

(57) ABSTRACT

A first communication terminal includes a first communication device, a first touch panel for displaying motion picture contents, and a first processor for accepting input of a hand-drawing image. The first processor transmits a hand-drawing image input during display of the motion picture contents and start information for identifying a point of time when input of the hand-drawing image at the motion picture contents is started to a second communication terminal. The second communication terminal includes a second touch panel for displaying motion picture contents, a second communication device for receiving the hand-drawing image and start information from the first communication terminal, and a second processor for displaying the hand-drawing image from the point of time when input of the hand-drawing image at the motion picture contents is started on the second touch panel, based on the start information.

### TECHNICAL FIELD

The present invention relates to a network system including at least first and second communication terminals capable of communication with each other, a communication method, and a communication terminal. Particularly, the present invention relates to a network system in which first and second communication terminals reproduce the same motion picture contents, a communication method, and a communication terminal.

### BACKGROUND ART

There is known a network system in which a plurality of communication terminals capable of connecting on the Internet exchange a hand-drawing image. For example, a server/client system, a P2P (Peer to Peer) system and the like can be cited. In such a network system, each communication terminal transmits and/or receives a hand-drawing image, text data, and the like. Each communication terminal provides a display of a hand-drawing image and/or text on the display device based on received data.

There is also known a communication terminal that downloads contents including a motion picture from a server that stores such contents, through the Internet or the like, to reproduce the downloaded contents.

For example, Japanese Patent Laying-Open No. 2006-4190 (PTL 1) discloses a chat service system for mobile phones. According to Japanese Patent Laying-Open No. 2006-4190 (PTL 1), the system includes a distribution server causing a plurality of mobile phone terminals and a Web terminal for an operator, connected for communication on the Internet, to form a motion picture display region and text display region on the browser display screen of the terminal, and distribute the motion picture data that is streaming-displayed at the motion picture display region, and a chat server supporting a chat between the mobile phone terminals and the operator Web terminal and causing chat data that is constituted of text data to be displayed at the text display region. The chat server allows each operator Web terminal to establish, relative to the plurality of mobile phone terminals, a chat channel independently for each mobile phone terminal.

### CITATION LIST

### Patent Literature

PTL 1: Japanese Patent Laying-Open No. 2006-4190

### SUMMARY OF INVENTION

### Technical Problem

It is difficult for a plurality of users to transmit/receive information related to the motion picture contents while looking at the motion picture contents. For example, the progressing state of the contents may differ between each of the communication terminals. There is a possibility that the intention of a user transmitting (entering) information cannot be conveyed effectively to a user receiving (viewing) the information. Furthermore, even if the user of the first communication terminal wishes to send comments on a first scene, there is a possibility that the relevant comments will be displayed in a second scene at the second communication terminal.

The present invention is directed to solving such problems, and an object is to provide a network system in which the intention of a user transmitting (entering) information can be conveyed effectively to a user receiving (viewing) the information, a communication method, and a communication terminal.

### Solution to Problem

According to an aspect of the present invention, there is provided a network system including first and second communication terminals. The first communication terminal includes a first communication device for communicating with the second communication terminal, a first touch panel for displaying motion picture contents, and a first processor for accepting input of a hand-drawing image via the first touch panel. The first processor transmits the hand-drawing image input during display of the motion picture contents, and start information for identifying a point of time when input of the hand-drawing image at the motion picture contents is started to the second communication terminal via the first communication device. The second communication terminal includes a second touch panel for displaying the motion picture contents, a second communication device for receiving the hand-drawing image and start information from the first communication terminal, and a second processor for displaying the hand-drawing image from the point of time when input of the hand-drawing image at the motion picture contents is started, on the second touch panel, based on the start information.

Preferably, the network system further includes a contents server for distributing motion picture contents. The first processor obtains motion picture contents from the contents server according to a download instruction, and transmits motion picture information for identifying the motion picture contents obtained to the second communication terminal via the first communication device. The second processor obtains the motion picture contents from the contents server based on the motion picture information.

Preferably, the first processor transmits an instruction to eliminate the hand-drawing image to the second communication terminal via the first communication device, when the scene of the motion picture contents changes and/or when an instruction to clear the input hand-drawing image is accepted.

Preferably, the second processor calculates a time starting from the point of time when input is started up to a point of time when a scene in the motion picture contents is changed, and determines a drawing speed of the hand-drawing image on the second touch panel based on the calculated time.

Preferably, the second processor calculates the length of a scene in the motion picture contents including the point of time when input is started, and determines the drawing speed of the hand-drawing image on the second touch panel based on the calculated length.

According to another aspect of the present invention, there is provided a communication method at a network system including first and second communication terminals capable of communication with each other. The communication method includes the steps of: displaying, by the first communication terminal, motion picture contents; accepting, by the first communication terminal, input of a hand-drawing image; transmitting, by the first communication terminal, to the second communication terminal the hand-drawing image input during display of the motion picture contents and start information for identifying the point of time when input of the hand-drawing image at the motion picture contents is started; displaying, by the second communication terminal, the motion picture contents; receiving, by the second communication terminal, the hand-drawing image and start information from the first communication terminal; and displaying, by the second communication terminal, the hand-drawing image from the point of time when input of the hand-drawing image at the motion picture contents is started, based on the start information.

According to another aspect of the present invention, there is provided a communication terminal capable of communicating with an other communication terminal. The communication terminal includes a communication device for communicating with an other communication terminal, a touch panel for displaying motion picture contents, and a processor for accepting input of a first hand-drawing image via the touch panel. The processor transmits the first hand-drawing image input during display of the motion picture contents and first start information for identifying the point of time when input of the first hand-drawing image at the motion picture contents is started to the other communication terminal via the communication device, receives a second hand-drawing image and second start information from the other communication terminal, and causes display of the second hand-drawing image from the point of time when input of the second hand-drawing image at the motion picture contents is started, on the touch panel, based on the second start information.

According to another aspect of the present invention, there is provided a communication method at a communication terminal including a communication device, a touch panel, and a processor. The communication method includes the steps of: causing, by the processor, display of motion picture contents on the touch panel; accepting, by the processor, input of a first hand-drawing image via the touch panel; transmitting, by the processor, the first hand-drawing image input during display of the motion picture contents and start information for identifying the point of time when input of the first hand-drawing image at the motion picture contents is started to an other communication terminal via the communication device; receiving, by the processor, a second hand-drawing image and second start information from the other communication terminal via the communication device; and causing, by the processor, display of the second hand-drawing image from the point of time when input of the second hand-drawing image at the motion picture contents is started on the touch panel, based on the second start information.

### Advantageous Effects of Invention

By a network system, communication method, and communication terminal of the present invention, the intention of a user transmitting (entering) information can be conveyed more effectively to a user receiving (viewing) the information.

### BRIEF DESCRIPTION OF DRAWINGS

FIG. 1 schematically represents an example of a network system according to an embodiment.

FIG. 2 is a sequence diagram schematically representing an operation in the network system of the embodiment.

FIG. 3 is a pictorial representation of the transition of the display at a communication terminal in line with the operation overview of the present embodiment.

FIG. 4 is a pictorial representation of the operation overview related to input and drawing of a hand-drawing image during reproduction of motion picture contents according to the embodiment.

FIG. 5 is a pictorial representation of an appearance of a mobile phone according to the present embodiment.

FIG. 6 is a block diagram representing a hardware configuration of the mobile phone of the present embodiment.

FIG. 7 is a pictorial representation of various data structures constituting a memory according to the present embodiment.

FIG. 8 is a block diagram of a hardware configuration of a chat server according to the present embodiment.

FIG. 9 is a pictorial representation of a data structure of a room management table stored in a memory or hard disk of the chat server according to the present embodiment.

FIG. 10 is a flowchart of the procedure of P2P communication processing at a mobile phone according to a first embodiment.

FIG. 11 is a pictorial representation of a data structure of transmission data according to the first embodiment.

FIG. 12 is a flowchart representing the procedure of a modification of P2P communication processing at the mobile phone according to the first embodiment.

FIG. 13 is a flowchart of the procedure of input processing at the mobile phone according to the first embodiment.

FIG. 14 is a flowchart of the procedure of pen information setting processing at the mobile phone according to the present embodiment.

FIG. 15 is a flowchart of the procedure of hand-drawing processing at the mobile phone according to the first embodiment.

FIG. 16 is a flowchart of the procedure of a modification of input processing at the mobile phone according to the first embodiment.

FIG. 17 is a flowchart of the procedure of hand-drawing image display processing at the mobile phone according to the first embodiment.

FIG. 18 is a flowchart of the procedure of first drawing processing at the mobile phone according to the first embodiment.

FIG. 19 is a first pictorial representation for describing hand-drawing image display processing according to the first embodiment.

FIG. 20 is a flowchart of the procedure of a modification of hand-drawing image display processing at the mobile phone according to the first embodiment.

FIG. 21 is a flowchart of the procedure of second drawing processing at the mobile phone according to the first embodiment.

FIG. 22 is a second pictorial representation for describing hand-drawing image display processing according to the first embodiment.

FIG. 23 is a flowchart of the procedure of another modification of hand-drawing image display processing at the mobile phone according to the first embodiment.

FIG. 24 is a flowchart representing the procedure of third drawing processing at the mobile phone according to the first embodiment.

FIG. 25 is a third pictorial representation for describing hand-drawing image display processing according to the first embodiment.

FIG. 26 is a flowchart of the procedure of P2P communication processing at a mobile phone according to a second embodiment.

FIG. 27 is a pictorial representation of a data structure of transmission data according to the second embodiment.

FIG. 28 is a flowchart of the procedure of input processing at the mobile phone according to the second embodiment.

FIG. 29 is a flowchart of the procedure of hand-drawing processing at the mobile phone according to the second embodiment,

FIG. 30 is a flowchart of the procedure of display processing at the mobile phone according to the second embodiment.

FIG. 31 is a flowchart of the procedure of an exemplary application of display processing at the mobile phone according to the second embodiment.

FIG. 32 is a flowchart of the procedure of hand-drawing image display processing at the mobile phone according to the second embodiment.

### DESCRIPTION OF EMBODIMENTS

Embodiments will be described hereinafter with reference to the drawings. In the description, the same elements have the same reference characters allotted, and their designation and function are also identical. Therefore, detailed description thereof will not be repeated.

The following description is based on a mobile phone 100 as a typical example of a “communication terminal”. The communication terminal may be any other information communication device that can be connected on a network such as a personal computer, a car navigation system (satellite navigation system), a PND (Personal Navigation Device), a PDA (Personal Data Assistance), a game machine, an electronic dictionary, an electronic book, or the like.

### First Embodiment

### Overall Configuration of Network System 1

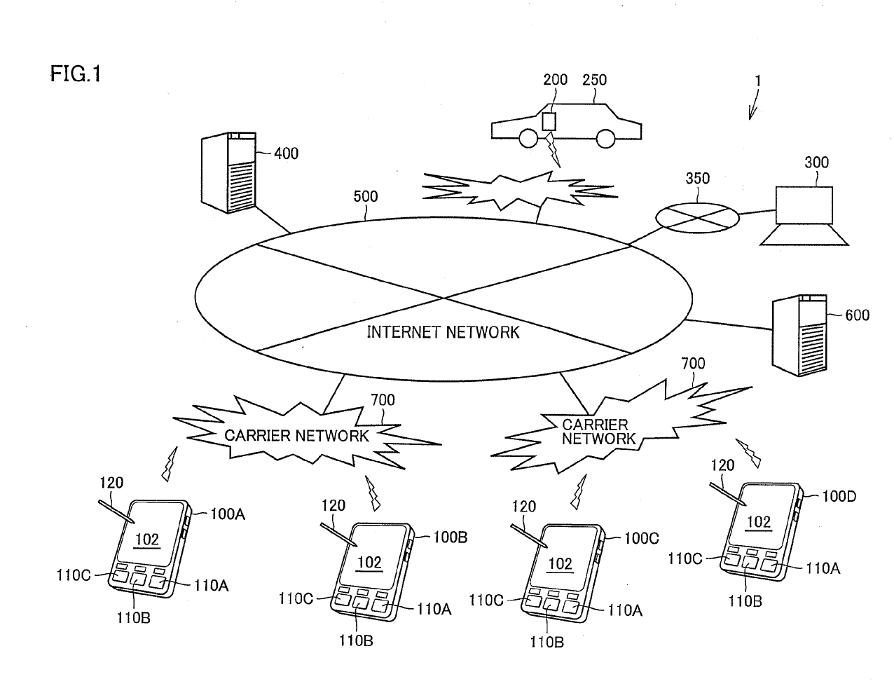

First, an entire configuration of a network system 1 according to the present embodiment will be described. FIG. 1 schematically shows an example of network system 1 according to the present embodiment. As shown in FIG. 1, network system 1 includes mobile phones 100A, 100B, 100C and 100D, a chat server (first server device) 400, a contents server (second server device) 600, an INTERNET (first network) 500, and a carrier network (second network) 700. Network system 1 of the present embodiment includes a car navigation device 200 mounted on a vehicle 250, and a personal computer (PC) 300.

For the sake of simplification, network system 1 of the present embodiment will be described based on the case where first mobile phone 100A, second mobile phone 100B, third mobile phone 100C and fourth mobile phone 100D are incorporated. Mobile phones 100A, 100B, 100C and 100D may be generically referred to as mobile phone 100 when a configuration or function common to each of mobile phones 100A, 100B, 100C and 100D is described. Furthermore, mobile phones 100A, 100B, 100C and 100D, car navigation device 200, and personal computer 300 may also be generically referred to as a communication terminal when a configuration or function common to each thereof is to be described.

Mobile phone 100 is configured to allow connection to carrier network 700. Car navigation device 200 is configured to allow connection to Internet 500. Personal computer 300 is configured to allow connection to Internet 500 via a local area network (LAN) 350 or a wide area network (WAN). Chat server 400 is configured to allow connection to Internet 500. Contents server 600 is configured to allow connection to Internet 500.

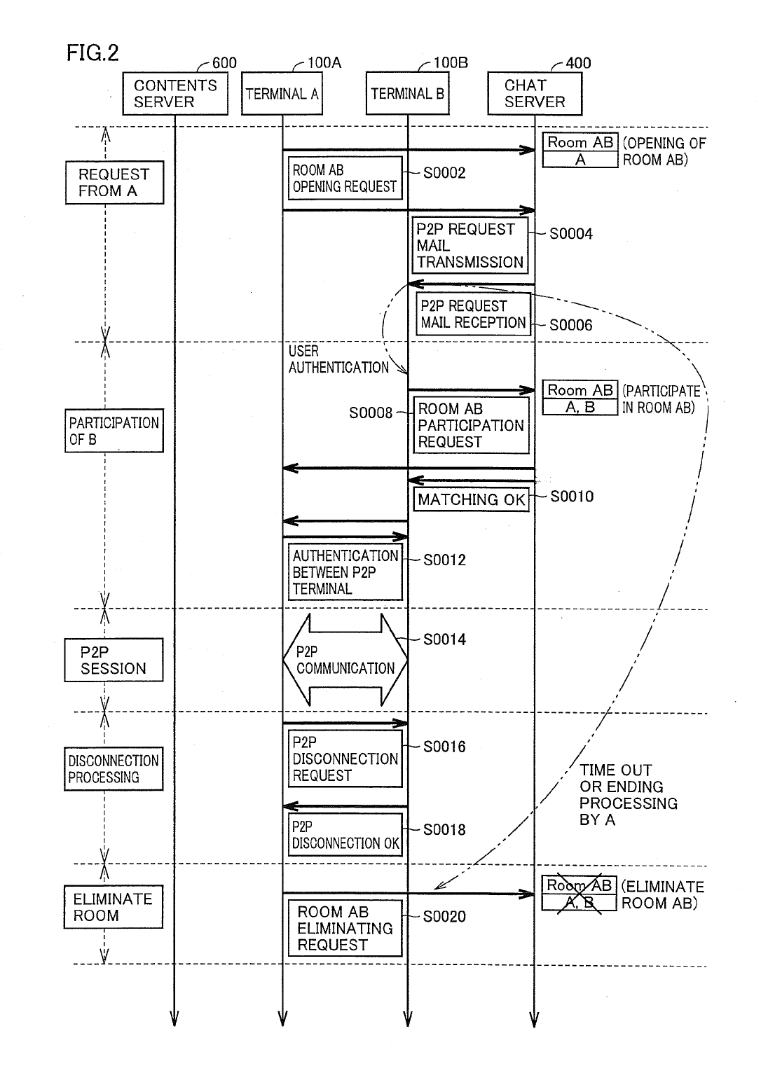

In more detail, first mobile phone 100A, second mobile phone 100B, third mobile phone 100C and fourth mobile phone 100D, car navigation device 200 and personal computer 300 can be connected with each other and transmit/receive data mutually via Internet 500 and/or carrier network 700 and/or a mail transmission server (chat server 400 in FIG. 2).

In the present embodiment, mobile phone 100, car navigation device 200, and personal computer 300 have identification information for identifying itself (for example, mail address, Internet protocol (IP) address, or the like) assigned. Mobile phone 100, car navigation device 200, and personal computer 300 can store the identification information of another communication terminal in its internal recording medium, and can carry out data transmission/reception with that other communication terminal via carrier network 700 or Internet 500 based on the identification information.

Mobile phone 100, car navigation device 200, and personal computer 300 of the present embodiment can use the IP address assigned to another terminal for data transmission/reception with the relevant other communication terminal without the intervention of servers 400 and 600. In other words, mobile phone 100, car navigation device 200, and personal computer 300 in network system 1 of the present embodiment can establish the so-called P2P (Peer to Peer) type network.

When each communication terminal is to gain access to chat server 400, i.e. each communication terminal gains access on the Internet, it is assumed that an IP address is assigned by chat server 400 or a server device not shown. Since the details of this IP address assigning process is well known, description thereof will not be repeated.

Mobile phone 100, car navigation device 200, and personal computer 300 can receive various motion picture contents from contents server 600 via Internet 500. The users of mobile phone 100, car navigation device 200, and personal computer 300 can view the motion picture contents from contents server 600.

<Overall Operation Overview of Network System 1>

The operation overview of network system 1 according to the present embodiment will be described hereinafter. FIG. 2 represents the sequence of the operation overview in network system 1 of the present embodiment. For the sake of description, the overview of the communication processing between first mobile phone 100A and second mobile phone 100B will be described hereinafter.

As shown in FIGS. 1 and 2, each communication terminal of the present embodiment must first exchange (obtain) the IP address of the other party for performing P2P type data transmission/reception. Upon obtaining the IP address of the other party, each communication terminal sends a message of a hand-drawing image, an attach file, or the like to another communication terminal through the P2P type data transmission/reception.

The following description is based on the case where each communication terminal transmits/receives a message and/or attach file via a chat room generated by chat server 400. Further, the case where first mobile phone 100A generates a new chat room, and invites a second mobile phone 100B to that chat room will be described. Chat server 400 may be configured to play the role of contents server 600.

First, first mobile phone 100A (terminal A in FIG. 2) requests chat server 400 of an IP registration (log in) (step S0002). First mobile phone 100A may obtain an IP address at the same time, or obtain an IP address in advance. Specifically, first mobile phone 100A transmits to chat server 400 the mail address and IP address of first mobile phone 100A, the mail address of second mobile phone 100B, and a message requesting generation of a new chat room via carrier network 700, a mail transmission server (chat server 400) and Internet 500.

Chat server 400 responds to the request to store the mail address of first mobile phone 100A in association with its IP address. Chat server 400 produces a room name, and generates a chat room of the relevant room name, based on the mail address of first mobile phone 100A and the mail address of second mobile phone 100B. At this stage, chat server 400 may notify first mobile phone 100A that generation of a chat room is completed. Chat server 400 stores the room name and the IP address of the participating communication terminal in association.

Alternatively, first mobile phone 100A produces a room name of a new chat room, and transmits that room name to chat server 400, based on the mail address of first mobile phone 100A and the mail address of second mobile phone 100B. Chat server 400 generates a new chat room based on the room name.

First mobile phone 100A transmits to second mobile phone 100B a mail message informing that a new chat room has been generated, i.e. requesting P2P participation indicating an invitation to that chat room (step S0004, step S0006). Specifically, first mobile phone 100A transmits P2P participation request mail to second mobile phone 100E via carrier network 700, mail transmission server (chat server 400) and Internet 500 (step S0004, step S0006).

Upon receiving the P2P participation request mail (step S0006), second mobile phone 100B produces a room name based on the mail address of first mobile phone 100A and the mail address of second mobile phone 100B, and transmits to chat server 400 the mail address and IP address of second mobile phone 100B as well as a message indicating participation in the chat room of that room name (step S0008). Second mobile phone 100B may obtain the IP address at the same time, or first obtain an IP address, and then gain access to chat server 400.

Chat server 400 accepts that message and determines whether the mail address of second mobile phone 100B corresponds to the room name, and then stores the mail address of second mobile phone 100B in association with the IP address. Then, chat server 400 transmits to first mobile phone 100A a mail message informing that second mobile phone 100B is participating in the chat room and the IP address of second mobile phone 100B (step S0010). At the same time, chat server 400 transmits to second mobile phone 100B a mail message informing acceptance of the participation in the chat room and the IP address of first mobile phone 100A.

First mobile phone 100A and second mobile phone 100B obtain the mail address and IP address of the other party to authenticate each other (step S0012). Upon completing authentication, first mobile phone 100A and second mobile phone 100B initiate P2P communication (chat communication) (step S0014). The operation overview during P2P communication will be described afterwards.

In response to first mobile phone 100A transmitting a message informing disconnection of P2P communication to second mobile phone 100B (step S0016), second mobile phone 100B transmits a message informing that the disconnection request has been accepted to first mobile phone 100A (step S0018). First mobile phone 100A transmits a request for eliminating the chat room to chat server 400 (step S0020). Chat server 400 eliminates the chat room.

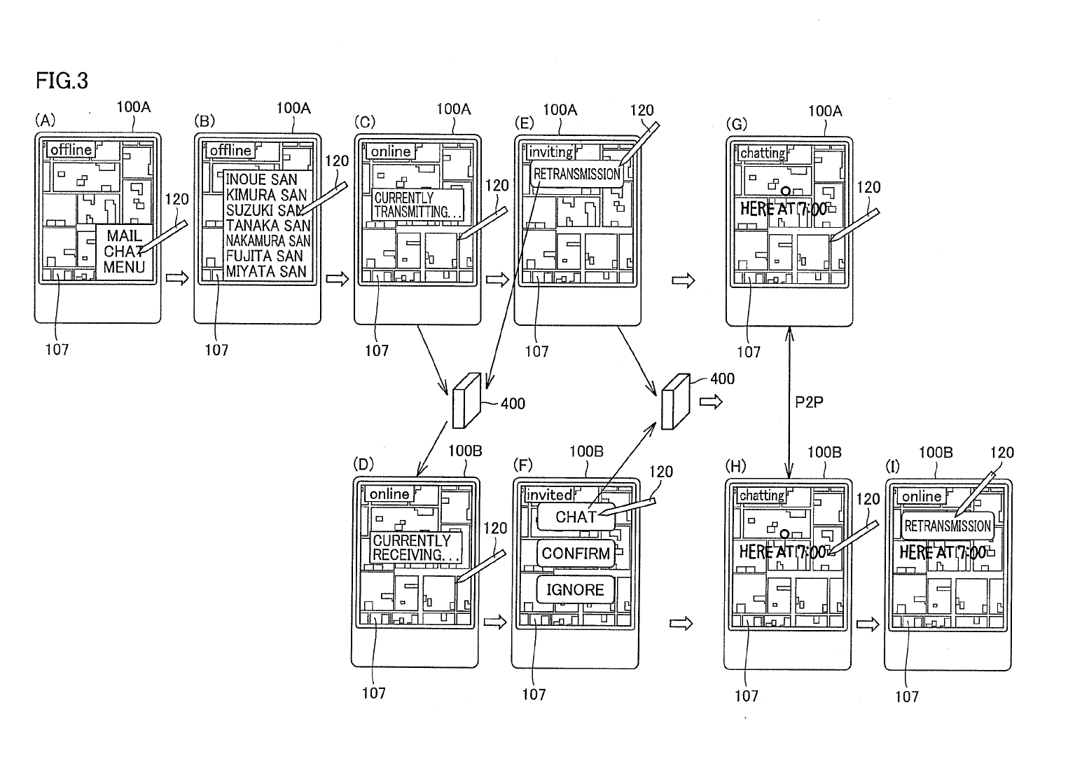

The operation overview of network system 1 according to the present embodiment will be described hereinafter in further detail with reference to FIGS. 2 and 3. FIG. 3 is a pictorial representation of the transition in the display at a communication terminal in line with the operation overview according to the present embodiment. The following description is based on the case where first mobile phone 100A and second mobile phone 100B transmit/receive a hand-drawing image while displaying the contents obtained from contents server 600 as the background. As used herein, the contents may be a motion picture image or a still image.

As shown in FIG. 3 (A), initially first mobile phone 100A receives and displays the contents. In the case where the user of first mobile phone 100A wishes to have a chat with the user of second mobile phone 100B while viewing the contents, first mobile phone 100A accepts a chat starting instruction. As shown in FIG. 3 (B), first mobile phone 100A accepts an instruction to select the other party user.

As shown in FIG. 3 (C), first mobile phone 100A transmits to second mobile phone 100B the information to identify the contents via the mail transmission server (chat server 400) (step S0004). As shown in FIG. 3 (D), second mobile phone 100B receives information from first mobile phone 100A (step S0006). Second mobile phone 100B receives and displays the contents based on the relevant information.

First mobile phone 100A and second mobile phone 100B may both receive the contents from contents server 600 upon starting P2P communication, i.e. during P2P communication.

As shown in FIG. 3 (E), first mobile phone 100A can also repeat mail transmission without P2P communication with second mobile phone 100B. Upon completion of mail transmission, first mobile phone 100A registers its own IP address at chat server 400, and requests generation of a new chat room based on the mail address of first mobile phone 100A and the mail address of second mobile phone 100B (step S0002).

As shown in FIG. 3 (F), second mobile phone 100B accepts an instruction to initiate a chat, and transmits to chat server 400 the room name, a message informing participation in the chat room, and its own IP address (step 0008). First mobile phone 100A obtains the IP address of second mobile phone 100B, and second mobile phone 100B obtains the IP address of first mobile phone 100A (step S0010) to authenticate each other (step S0012).

Thus, as shown in FIG. 3 (G) and H), first mobile phone 100A and second mobile phone 100B can carry out P2P communication (step S0014). In other words, first mobile phone 100A and second mobile phone 100B according to the present embodiment can transmit/receive information such as a hand-drawing image while displaying the downloaded contents.

More specifically, in the present embodiment, first mobile phone 100A accepts input of a hand-drawing image from a user, and displays the hand-drawing image over the contents. First mobile phone 100A transmits the hand-drawing image to second mobile phone 100B. Second mobile phone 100B displays the hand-drawing image on the contents based on the hand-drawing image from first mobile phone 100A.

In an opposite manner, second mobile phone 100B accepts input of a hand-drawing image from a user and displays that hand-drawing image over the contents. Second mobile phone 100B transmits the hand-drawing image to first mobile phone 100A. Second mobile phone 100B displays the hand-drawing image over the contents based on the hand-drawing image from first mobile phone 100A.

After first mobile phone 100A disconnects P2P communication (step S0016, step S0018), second mobile phone 100B can carry out mail transmission with first mobile phone 100A and the like, as shown in FIG. 3 (I). It is to be noted that P2P communication can be conducted in a TCP/IP communication scheme and mail transmission/reception can be conducted in an HTTP communication scheme. In other words, mail transmission/reception is allowed also during P2P communication.

<Operation Overview Related to Hand-Drawing Image Transmission/Reception at Network System 1>

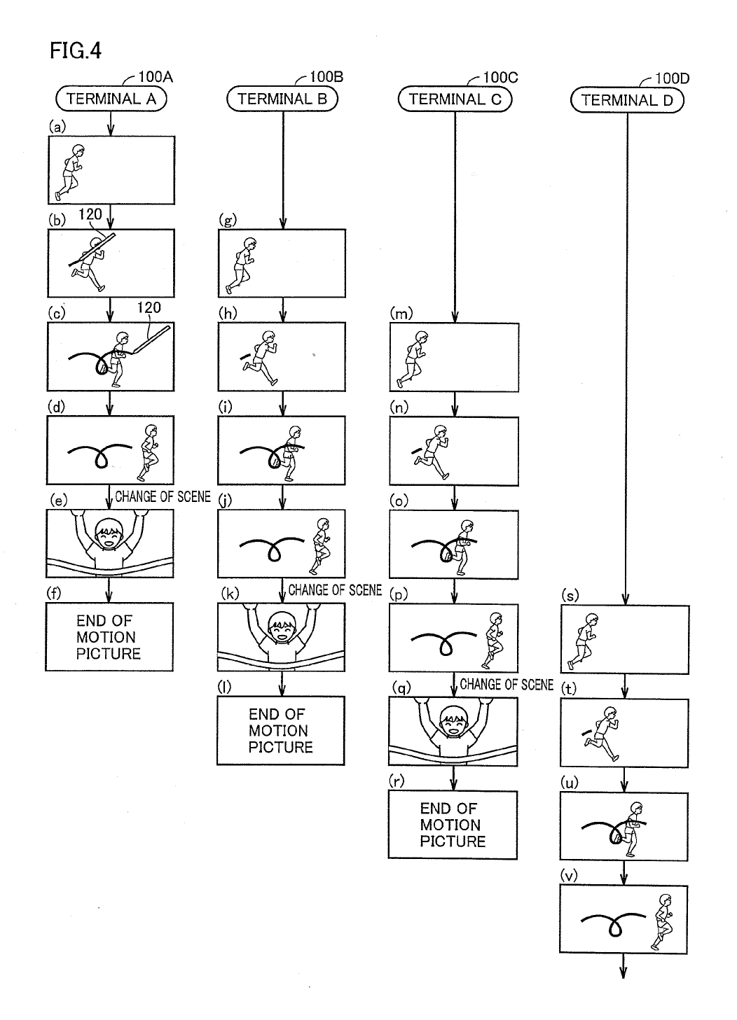

The operation overview related to input and drawing of a hand-drawing image during reproduction of motion picture contents will be described in further detail hereinafter. FIG. 4 is a pictorial representation of the operation overview related to input and drawing of a hand-drawing image during reproduction of motion picture contents. The following description is based on the case where first mobile phone 100A and second mobile phone 100B start a chat communication, followed by a third mobile phone 100C starting a chat communication, further followed by a fourth mobile phone 100D starting a chat communication.

Referring to FIG. 4, first mobile phone 100A, second mobile phone 100B, third mobile phone 100C and fourth mobile phone 100D begin downloading motion picture contents from contents server 600 at a timing different from each other. Then, first mobile phone 100A, second mobile phone 100B, third mobile phone 100C and fourth mobile phone 100D begin to reproduce the motion picture contents at a timing different from each other. Naturally, first mobile phone 100A, second mobile phone 100B, third mobile phone 100C and fourth mobile phone 100D will end the reproduction of the motion picture contents at a different timing.

One mobile phone (first mobile phone 100A in FIG. 4) accepts input of information such as a hand-drawing image during the reproduction of motion picture contents. In network system 1 according to the present embodiment, other mobile phones (second mobile phone 100B, third mobile phone 100C, and fourth mobile phone 100D in FIG. 4) start to draw the hand-drawing image at the timing (point of time when input is started) corresponding to input of the hand-drawing image on the motion picture contents. In other words, each of the mobile phones 100A-100D differ in the time of starting drawing of a hand-drawing image corresponding to the difference in the time of starting the motion picture contents. Naturally, the time when the motion picture contents ends will differ between each of mobile phones 100A-100D.

In other words, the length of period starting when the motion picture contents is started up to the time when drawing a hand-drawing image is started is the same for each of mobile phones 100A-100D. Namely, each of mobile phones 100A-100D will display the hand-drawing image input at first mobile phone 100A on the same scene in the same motion picture contents. In other words, each of mobile phones 100A-100D begins to draw the hand-drawing image input at first mobile phone 100A on the relevant motion picture contents at an elapse of the same time from starting the motion picture contents.

Thus, in network system 1 of the present embodiment, the hand-drawing image input at a communication terminal can be displayed for other communication terminals on the same scene or same frame even though respective communication terminals download the motion picture contents individually from contents server 600.

Therefore, when the user of one communication terminal wishes to convey his/her information related to a certain scene, the relevant information will be displayed together with the certain one scene at other communication terminals. In other words, the intention of a user transmitting (entering) information can be conveyed effectively to a user receiving (viewing) the information.

A configuration of network system 1 to realize such function will be described in detail hereinafter.

<Hardware Configuration of Mobile Phone 100>

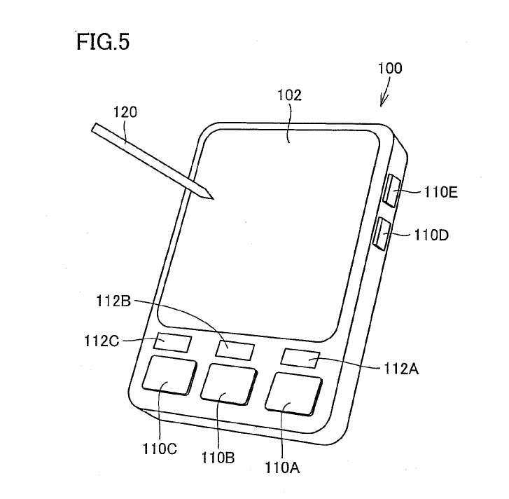

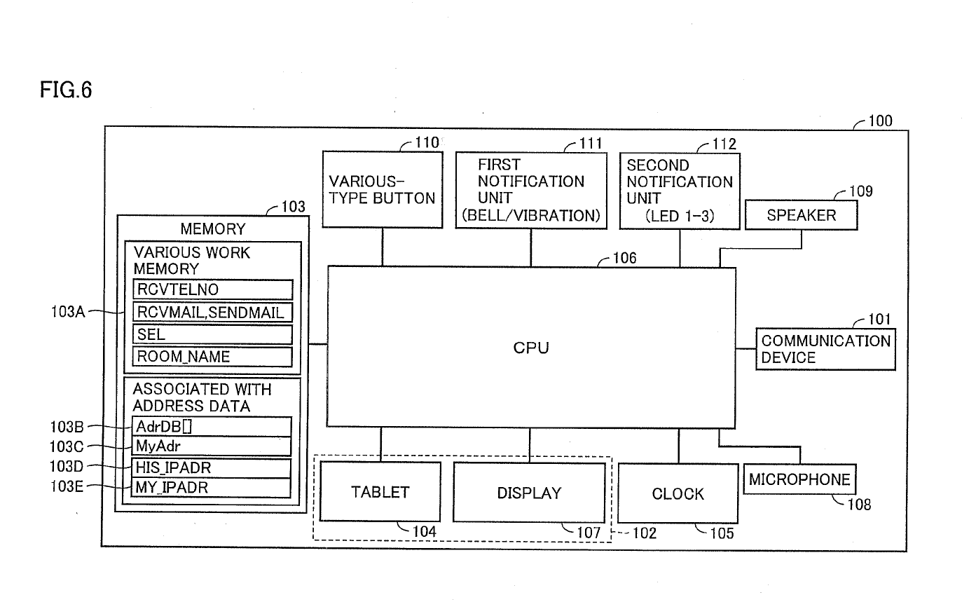

The hardware configuration of mobile phone 100 according to the present embodiment will be described hereinafter. FIG. 5 is a pictorial representation of an appearance of mobile phone 100 according to the present embodiment. FIG. 6 is a block diagram of the hardware configuration of mobile phone 100 according to the present embodiment.

As shown in FIGS. 5 and 6, mobile phone 100 according to the present embodiment includes a communication device 101 transmitting/receiving data to/from an external network, a memory 103 storing a program and various database, a central processing unit (CPU) 106, a display 107, a microphone to which externally applied sound is received, a speaker 109 providing sound outwards, various-type button 110 receiving input of information and/or instruction, a first notification unit 111 providing audio informing reception of externally applied communication data and/or conversation signal, and a second notification unit 112 displaying indication of receiving externally applied communication data and/or conversation signal.

Display 107 according to the present embodiment realizes a touch panel 102 constituted of a liquid crystal panel or a CRT. In other words, mobile phone 100 of the present embodiment has a pen tablet 104 provided at the upper side (top side) of display 107. Accordingly, the user can enter hand-drawing such as graphical information to CPU 106 via pen tablet 104 by using a stylus pen 120 or the like.

The user can input hand-drawing by other methods, as set forth below. By using a special pen that outputs infrared ray or ultrasonic wave, the movement of the pen is identified by a reception unit receiving an infrared ray or ultrasonic wave emitted from the pen. In this case, by connecting the relevant reception unit to a device that stores the trace, CPU 106 can receive the trace output from the relevant device as hand-drawing input.

Alternatively, the user can write down, on an electrostatic panel, a hand-drawing image using his/her finger or a pen corresponding to the electrostatic field.

Thus, display 107 (touch panel 102) provides the display of an image or text based on the data output from CPU 106. For example, display 107 shows the motion picture contents received via communication device 101. Display 107 can show a hand-drawing image overlapped on the motion picture contents, based on the hand-drawing image accepted via tablet 104 or accepted via communication device 101.

Various-type button 110 accepts information from a user through key input operation or the like. For example, various-type button 110 includes a TEL button 110A for accepting/dispatching conversation, a mail button 110B for accepting/dispatching mail, a P2P button 110C for accepting/dispatching P2P communication, an address book button 110D for invoking address book data, and an end button 110E for ending various processing. In other words, various-type button 110 selectively accepts, from a user, an instruction to participate in a chat room and/or an instruction to display the mail contents when P2P participation request mail is received via communication device 101.

Furthermore, various-type button 110 may include a button to accept an instruction to start hand-drawing input, i.e. a button for accepting a first input. Various-type button 110 may also include a button for accepting an instruction to end a hand-drawing input, i.e. a button for accepting a second input.

First notification unit 111 issues a ringing sound via a speaker 109 or the like. Alternatively, first notification unit 111 has vibration capability. First notification unit 111 issues sound or causes mobile phone 100 to vibrate when called, when receiving mail, or when receiving P2P participation request mail.

Second notification unit 112 includes a telephone LED (Light Emitting Diode) 112A that blinks when receiving a call, a mail LED 112B that blinks when receiving mail, and P2P LED 112C that blinks when receiving P2P communication.

CPU 106 controls various elements in mobile phone 100. For example, various instructions are accepted from the user via various-type button 110 to transmit/receive data to/from communication device 101 or an external communication terminal via communication device 101.

Communication device 101 converts communication data from CPU 106 into communication signals for output to an external source. Communication device 101 converts externally applied communication signals into communication data for input to CPU 106.

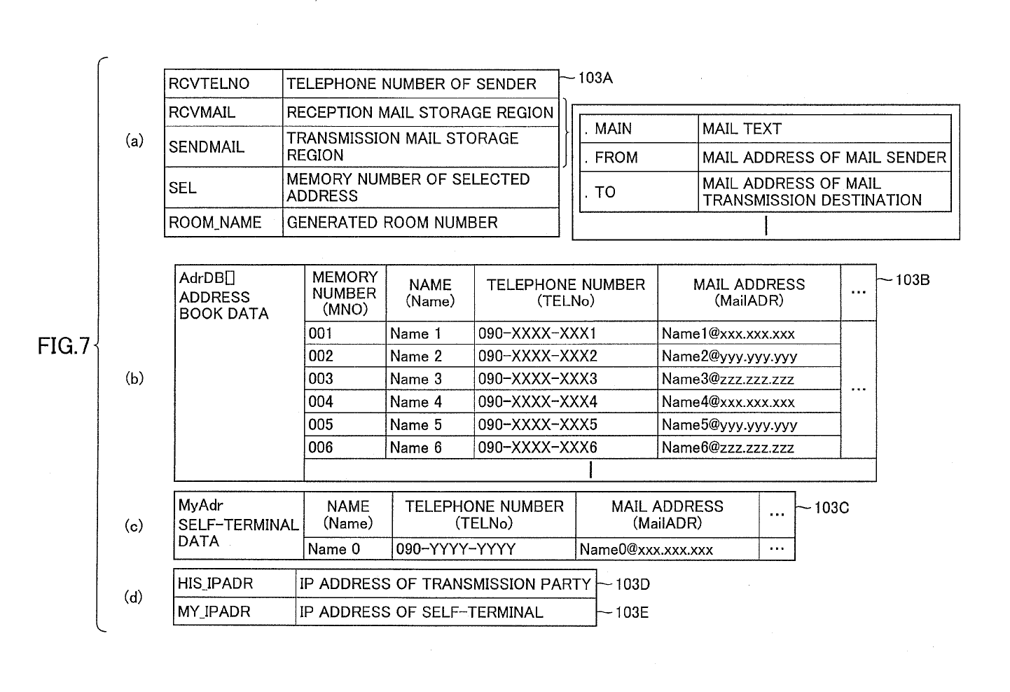

Memory 103 is realized by a random access memory (RAM) functioning as a work memory, a read only memory (ROM) for storing a control program and the like, a hard disk storing image data, and the like. FIG. 7 (a) is a pictorial representation of the data structure of various work memory 103A constituting memory 103. FIG. 7 (b) is a pictorial representation of address book data 103B stored in memory 103. FIG. 7 (c) is a pictorial representation of self-terminal data 103C stored in memory 103. FIG. 7 (d) is a pictorial representation of IP address data 103D of its own terminal and IP address data 103E of another terminal, stored in memory 103.

As shown in FIG. 7 (a), work memory 103A of memory 103 includes a RCVTELNO region storing the telephone number of the caller, a RCVMAIL region storing information associated with reception mail, a SENDMAIL region storing information associated with transmission mail, a SEL region storing the memory number of the selected address, a ROOMNAME region storing the produced room name, and the like. Work memory 103A does not have to store a telephone number. Information associated with reception mail includes mail text stored in a MAIN region, and the mail address of the mail sender stored in a FROM region of RCVMAIL. Information associated with transmission mail includes mail text stored in the MAIN region, and the mail address of the mail destination stored in the TO region of RCVMAIL.

As shown in FIG. 7 (b), address book data 103B has a memory number associated with each address (another communication terminal). Address book data 103B stores the name, telephone number, mail address, and the like for each address in association with each other.

As shown in FIG. 7 (c), the user name, telephone number, mail address and the like of its own terminal are stored in self-terminal data 103C.

As shown in FIG. 7 (d), IP address data 103D of its own terminal stores the self-terminal IP address. IP address data 103E of another terminal stores the IP address of the other terminal.

Each mobile phone 100 according to the present embodiment can transmit/receive data to/from another communication terminal by the method set forth above (refer to FIGS. 1-3), using the data shown in FIG. 7.

<Hardware Configuration of Chat Server 400 and Contents Server 600>

The hardware configuration of chat server 400 and contents server 600 according to the present embodiment will be described hereinafter. First, the hardware configuration of chat server 400 will be described.

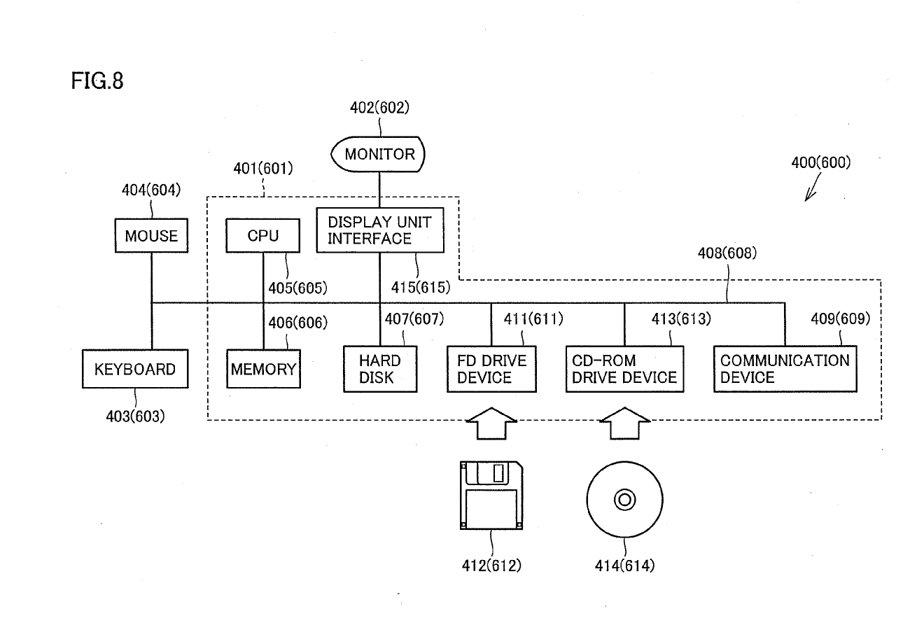

FIG. 8 is a block diagram of the hardware configuration of chat server 400 according to the present embodiment. As shown in FIG. 8, chat server 400 according to the present embodiment includes a CPU 405, a memory 406, a hard disk 407, and a communication device 409, connected with each other through an internal bus 408.

Memory 406 serves to store various information. For example, memory 406 temporarily stores data required for execution of a program at CPU 405. Hard disk 407 stores a program and/or database for execution by CPU 405. CPU 405 is a device controlling each element in chat server 400 for implementing various operations.

Communication device 409 converts the data output from CPU 405 into electrical signals for transmission outwards, and converts externally received electrical signals into data for input to CPU 405. Specifically, communication device 409 transmits the data from CPU 405 to a device that can be connected on the network such as mobile phone 100, car navigation device 200, personal computer 300, a game machine, an electronic dictionary, and an electronic book via Internet 500 and/or carrier network 700. Communication device 409 applies data received from a device that can be connected on the network such as mobile phone 100, car navigation device 200, personal computer 300, a game machine, an electronic dictionary, and an electronic book to CPU 405 via Internet 500 and/or carrier network 700.

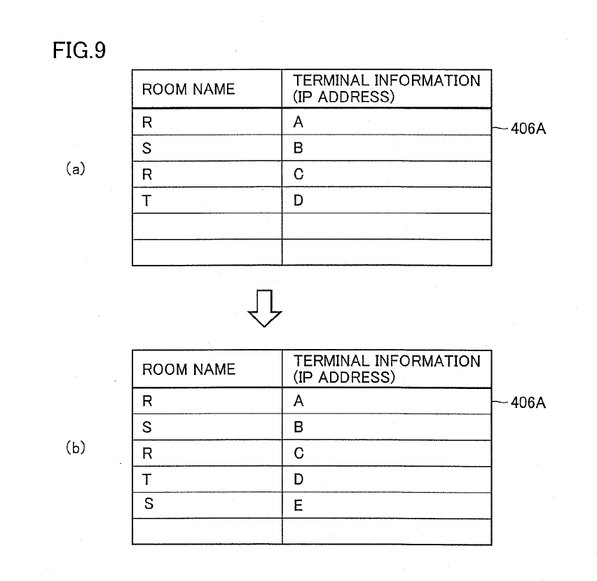

The data stored in memory 406 or hard disk 407 will be described hereinafter. FIG. 9 (a) is a first pictorial representation indicating the data structure of a room management table 406A stored in memory 406 or hard disk 407 in chat server 400. FIG. 9 (b) is a second pictorial representation indicating the data structure of room management table 406A stored in memory 406 or hard disk 407 in chat server 400.

As shown in FIGS. 9 (a) and (b), room management table 406A stores a room name and an IP address in association. For example, at a certain point of time, a chat room having the room name R, a chat room having the room name S, and a chat room having the room name T are generated at chat server 400, as shown in FIG. 9 (a). In the chat room of room name R, a communication terminal having an IP address of A and a communication terminal having an IP address of C are in the room. In the chat room of room name S, a communication terminal having an IP address of B is in the room. In the chat room of room name T, a communication terminal having an IP address of D is in the room.

As will be described afterwards, room name R is determined based on the mail address of the communication terminal having an IP address of A and the mail address of a communication terminal having an IP address of B by CPU 406. When a communication terminal having an IP address of E newly enters the chat room of room name S at the state of FIG. 9 (a), room management table 406A stores room name S and IP address E in association, as shown in FIG. 9 (b).

Specifically, when first mobile phone 100A requests generation of a new chat room (step S0002 in FIG. 2) at chat server 400, CPU 405 generates a room name based on the mail address of first mobile phone 100A and the mail address of second mobile phone 100B, and then stores the relevant room name and the IP address of first mobile phone 100A in association in room management table 406A.

When second mobile phone 100B request participation in the chat room to chat server 400 (step S0008 in FIG. 2), CPU 405 stores the relevant room name and IP address of second mobile phone 100B in association in room management table 406A. CPU 406 reads out the IP address of first mobile phone 100A corresponding to the relevant room name from room management table 406A. CPU 406 transmits the IP address of first mobile phone 100A to a second each communication terminal, and the IP address of second mobile phone 100B to first mobile phone 100A.

The hardware configuration of contents server 600 will be described hereinafter. As shown in FIG. 8, contents server 600 according to the present embodiment includes a CPU 605, a memory 606, a hard disk 607, and a communication device 609 connected with each other through an internal bus 608.

Memory 606 stores various types of information. For example, memory 606 temporarily stores data required for execution of a program at CPU 605. Hard disk 607 stores the program and/or database for execution by CPU 605. CPU 605 is a device for controlling various elements in contents server 600 to implement various operations.

Communication device 609 transmits data output from CPU 605 into electrical signals for transmission, and converts externally applied electrical signals into data for input to CPU 605. Specifically, communication device 609 transmits the data from CPU 605 to the device that can be connected on the network such as mobile phone 100, car navigation device 200, personal computer 300, a game machine, an electronic dictionary, and an electronic book via Internet 500, carrier network 700, and the like. Communication device 609 inputs the data received from a device that can be connected on the network such as mobile phone 100, car navigation device 200, personal computer 300, a game machine, an electronic dictionary, and an electronic book to CPU 605 via Internet 500, carrier network 700.

Memory 606 or hard disk 615 of contents server 600 stores motion picture contents. CPU 605 of contents server 600 receives a specification of contents (an address or the like indicating the storage destination of the motion picture contents) from first mobile phone 100A and second mobile phone 100B via communication device 609. Based on the specification of the contents, CPU 605 of contents server 600 reads out the motion picture contents corresponding to that specification from memory 606 to transmit the relevant contents to first mobile phone 100A and second mobile phone 100B via communication device 609.

<Communication Processing at Mobile Phone 100>

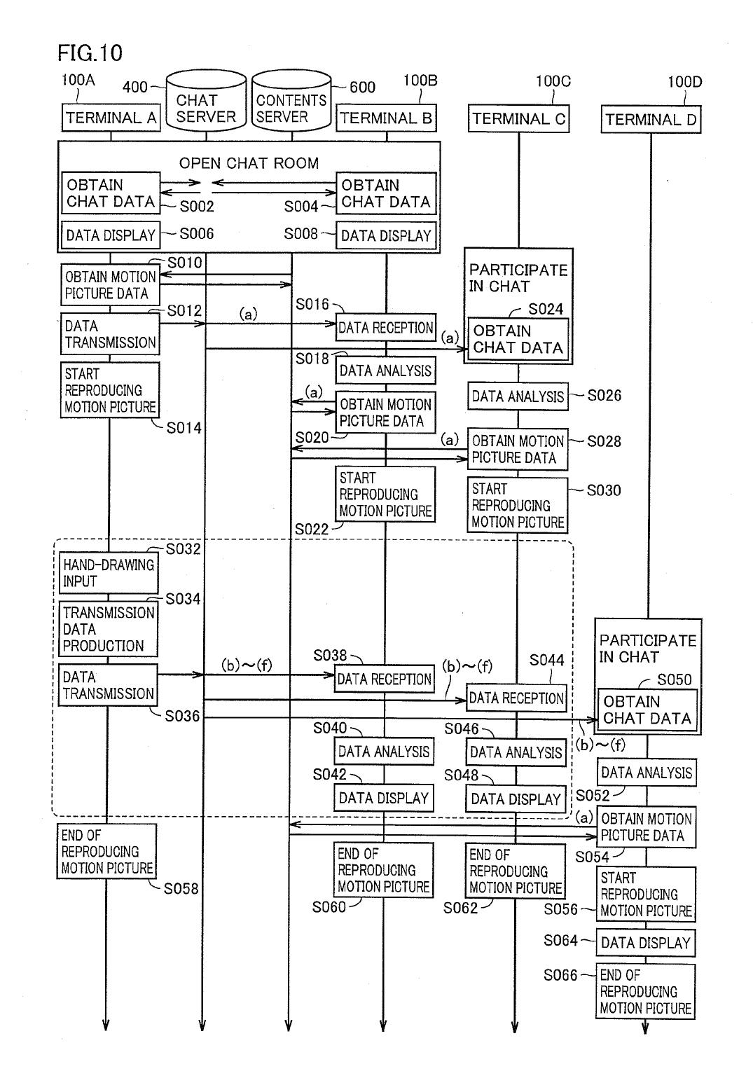

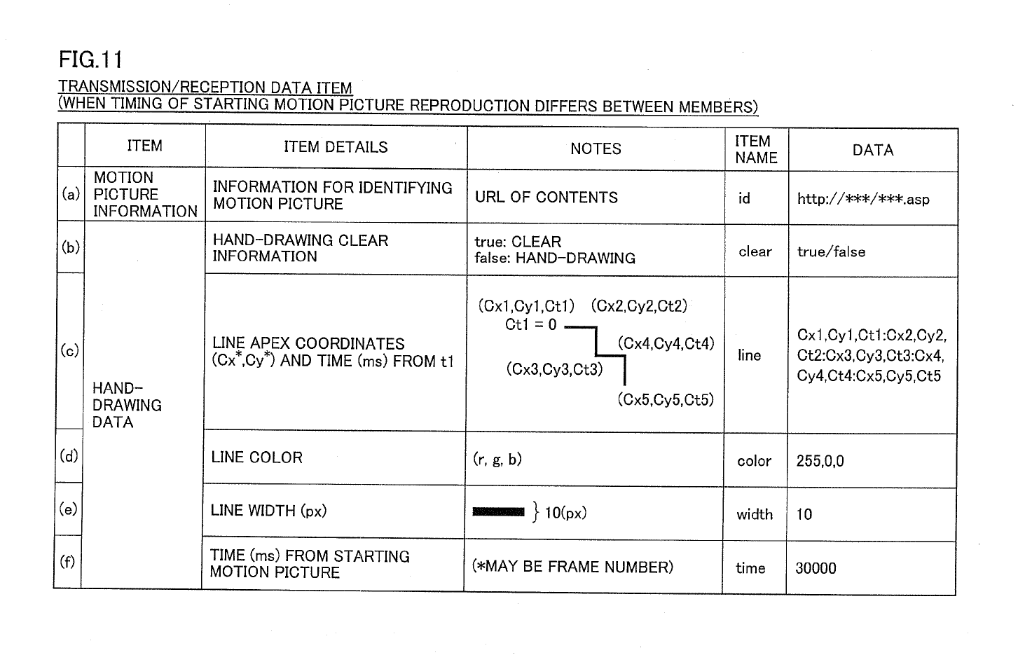

P2P communication processing at mobile phone 100 according to the present embodiment will be described hereinafter. FIG. 10 is a flowchart of the procedure of P2P communication processing at mobile phone 100 of the present embodiment. FIG. 11 is a pictorial representation indicating the data structure of transmission data according to the present embodiment.

Hereinafter, transmission of specification of motion picture contents, a hand-drawing image or the like from first mobile phone 100A to second mobile phone 100B will be described hereinafter. In the present embodiment, first mobile phone 100A and second mobile phone 100B transmits/receives data via chat server 400. However, data may be transmitted/received through P2P communication without the intervention of chat server 400. In this case, first mobile phone 100A must store data or transmit data to second mobile phone 100B or third mobile phone 100C, on behalf of chat server 400.

Referring to FIG. 10, CPU 106 of first mobile phone 100A (transmission side) obtains data associated with chat communication from chat server 400 via communication device 101 (step S002). Similarly, CPU 106 of second mobile phone 100B (recipient side) obtains data associated with chat communication from chat server 400 via communication device 101 (step S004).

As used herein “data associated with chat communication” includes the chat room ID, member's terminal information, notification (notice information), the chat contents up to the present time, and the like.

CPU 106 of first mobile phone 100A causes touch panel 102 to display a window for chat communication (step S006). Similarly, CPU 106 of second mobile phone 100B causes touch panel 102 to display a window for chat communication (step S008).

CPU 106 of first mobile phone 100A receives motion picture contents via communication device 101 based on a contents reproduction instruction from a user (step S010). More specifically, CPU 106 receives an instruction to specify motion picture contents from the user via touch panel 102. The user may directly enter URL (Uniform Resource Locator) at first mobile phone 100A, or select a link corresponding to the desired motion picture contents on the currently displayed Web page.

CPU 106 of first mobile phone 100A uses communication device 101 to transmit motion picture information (a) for identifying selected motion picture contents to another communication terminal participating in the chat via chat server 400 (step S012). Alternatively, CPU 106 of first mobile phone 100A uses communication device 101 to transmit motion picture information (a) for identifying selected motion picture contents directly to another communication terminal participating in the chat by P2P communication. As shown in FIG. 11, motion picture information (a) includes, for example, the URL indicating the stored location of the motion picture contents. CPU 405 of chat server 400 stores motion picture information (a) in memory 406 for any communication terminal subsequently participating in the chat.

As shown in FIG. 4 (a), CPU 106 of first mobile phone 100A begins to reproduce the received motion picture contents via touch panel 102 (step S014). CPU 106 may output the sound of motion picture contents via speaker 109.

CPU 106 of second mobile phone 100B receives motion picture information (a) from chat server 400 via communication device 101 (step S016). CPU 106 analyzes the motion picture information (step S018), and downloads the motion picture contents from contents server 600 (step S020). As shown in FIG. 4 (g), CPU 106 begins to reproduce the received motion picture contents via touch panel 102 (step S022). At this stage, CPU 106 may have the sound of the motion picture contents output via speaker 109.

The present example is based on, but not limited to the case where first mobile phone 100A and second mobile phone 100B obtain motion picture information during chat communication. First mobile phone 100A and second mobile phone 100B may obtain common motion picture information prior to chat communication.

It is assumed that third mobile phone 100C participates in the chat subsequently. CPU 106 of third mobile phone 100C obtains the chat data from chat server 400 via communication device 101 (step S024).

At this stage, chat server 400 stores motion picture information (a) from first mobile phone 100A. CPU 405 of chat server 400 transmits motion picture information (a) as a portion of the chat data to third mobile phone 100C via communication device 409.

CPU 106 of third mobile phone 100C analyzes the chat data to obtain motion picture information (step S026). CPU 106 obtains motion picture contents from contents server 600 based on the motion picture information (step S028). As shown in FIG. 4 (m), CPU 106 begins to reproduce the received motion picture contents via touch panel 102 (step S030). At this stage, CPU 106 may output the sound of the motion picture contents via speaker 109.

It is here assumed that CPU 106 accepts hand-drawing input by a user via touch panel 102 during reproduction of the motion picture contents at first mobile phone 100A (step S032).

More specifically, CPU 106 obtains change in the touching position on touch panel 102 (trace) by sequentially accepting touch coordinate data from touch panel 102 at every predetermined time. Then, as shown in FIG. 11, CPU 106 generates transmission data including hand-drawing clear information (b), information (c) indicating the trace of the touching position, information (d) indicating the line color, information (e) indicating the line width, and timing information (f) indicating the timing when hand-drawing input is started (step S034).

Hand-drawing clear information (b) includes information (true) for clearing the hand-drawing input up to that time or information (false) for continuing hand-drawing input. Information (c) indicating the trace of the touching position includes the coordinates of each apex constituting a hand-drawing stroke, and the elapsed time from the point of time when hand-drawing input corresponding to respective apexes is started. Timing information (f) also indicates the timing when the drawing of a hand-drawing image should be started. More specifically, timing information (f) includes the time (ms) from starting motion picture contents, information to identify a scene in the motion picture contents (scene number or the like), information to identify the frame in the motion picture contents (frame number or the like), when hand-drawing input is accepted at first mobile phone 100A.

At this stage, i.e. at step S032, CPU 106 causes display of the input hand-drawing image on the motion picture contents (overlapping on the motion picture contents) at touch panel 102. As shown in FIG. 4 (b)-(d), CPU 106 causes display of a hand-drawing image on touch panel 102, according to input of the hand-drawing image.

As shown in FIG. 4 (e), every time the scene in the motion picture contents is changed, the hand-drawing image input up to that time will be cleared at first mobile phone 100A of the present embodiment. CPU 106 may transmit clear information (true) using communication device 101 at the change of a scene.

CPU 106 repeats the processing of steps S032-S034 every time input of a hand-drawing image is accepted. Alternatively, CPU 106 repeats the processing of steps S032-S036 every time input of a hand-drawing image is accepted. As shown in FIG. 4 (f), CPU 106 ends the reproduction of the motion picture contents (step S058).

CPU 106 uses communication device 101 to transmit the relevant transmission data to another communication terminal participating in the chat via chat server 400 (step S036). CPU 405 of chat server 400 stores transmission data (b)-(f) in memory 406 for any communication terminal that comes to participate later on. At the current point of time, second mobile phone 100B and third mobile phone 100C are participating in the chat. Alternatively, CPU 106 uses communication device 101 to directly transmit the relevant transmission data to another communication terminal participating in the chat through P2P communication (step S036).

CPU 106 of second mobile phone 100B receives transmission data (b)-(f) from chat server 400 via communication device 101 (step S038). CPU 106 analyzes the transmission data (step S040). As shown in FIG. 4 (h)-(j), CPU 106 causes hand-drawing image to be drawn on the motion picture contents at touch panel 102 based on the timing information (f) of the relevant transmission data for every transmission data (step S042).

As shown in FIG. 4 (k), the hand-drawing image input up to that time will be cleared when the scene in the motion picture contents is changed, at second mobile phone 100B of the present embodiment. CPU 106 may eliminate the hand-drawing image based on clear information from first mobile phone 100A. Alternatively, CPU 106 may determine by itself that the scene has been changed, and eliminate the hand-drawing image. As shown in FIG. 4 (l), CPU 106 ends the reproduction of the motion picture contents (step S060).

CPU 106 of third mobile phone 100C receives the transmission data from chat server 400 via communication device 101 (step S044). CPU 106 analyzes the transmission data (step S046). As shown in FIG. 4 (n)-(p), CPU 106 causes the hand-drawing image to be drawn on the motion picture contents at touch panel 102 based on the timing information (f) of the relevant transmission data (step S048).

As shown in FIG. 4 (q), the hand-drawing image input up to that time will be cleared when the scene in the motion picture contents is changed, at third mobile phone 100C of the present embodiment. CPU 106 may eliminate the hand-drawing image based on clear information from first mobile phone 100A. Alternatively, CPU 106 may determine by itself that the scene has been changed, and eliminate the hand-drawing image. As shown in FIG. 4 (r), CPU 106 ends the reproduction of the motion picture contents (step S062).

Then, it is assumed that fourth mobile phone 100D comes to participate in the chat. More specifically, it is assumed that fourth mobile phone 100D participates in the chat after input of a hand-drawing image ends at first mobile phone 100A. Whether reproduction of the motion picture contents has ended or not at first mobile phone 100A, second mobile phone 100B and third mobile phone 100C is irrespective.

CPU 106 of fourth mobile phone 100D obtains the chat data from chat server 400 via communication device 101 (step, S050). At this stage, chat server 400 stores motion picture information (a) from first mobile phone 100A. CPU 405 of chat server 400 transmits motion picture information (a) and transmission data (b)-(f) stored up to that point of time as a portion of chat data to fourth mobile phone 100D via communication device 409.

CPU 106 of fourth mobile phone 100D analyzes the chat data to obtain the motion picture information and transmission data (step S052). CPU 106 obtains the motion picture contents from contents server 600 based on the motion picture information (step S054). As shown in FIG. 4 (s), CPU 106 begins to reproduce the received motion picture contents via touch panel 102 (step S056). At this stage, CPU 106 may output the sound of motion picture contents via speaker 109.

As shown in FIG. 4 (t)-(v), CPU 106 causes the hand-drawing image to be drawn on the motion picture contents at touch panel 102 based on the timing information (f) of the relevant transmission data, for each transmission data (step S064).

As shown in FIG. 4 (v), the hand-drawing image input up to that time will be cleared when the scene in the motion picture contents is changed, at fourth mobile phone 100D of the present embodiment. CPU 106 may eliminate the hand-drawing image based on clear information from first mobile phone 100A. Alternatively, CPU 106 may determine by itself that the scene has been changed, and eliminate the hand-drawing image.

Accordingly, the hand-drawing image is drawn at second mobile phone 100B, third mobile phone 100C and fourth mobile phone 100D at a timing identical to that in the motion picture contents having the hand-drawing image input at first mobile phone 100A. In other words, the desired information is drawn at the scene intended by the user of first mobile phone 100A even at second mobile phone 100B, third mobile phone 100C and fourth mobile phone 100D.

<Modification of Communication Processing at Mobile Phone 100>

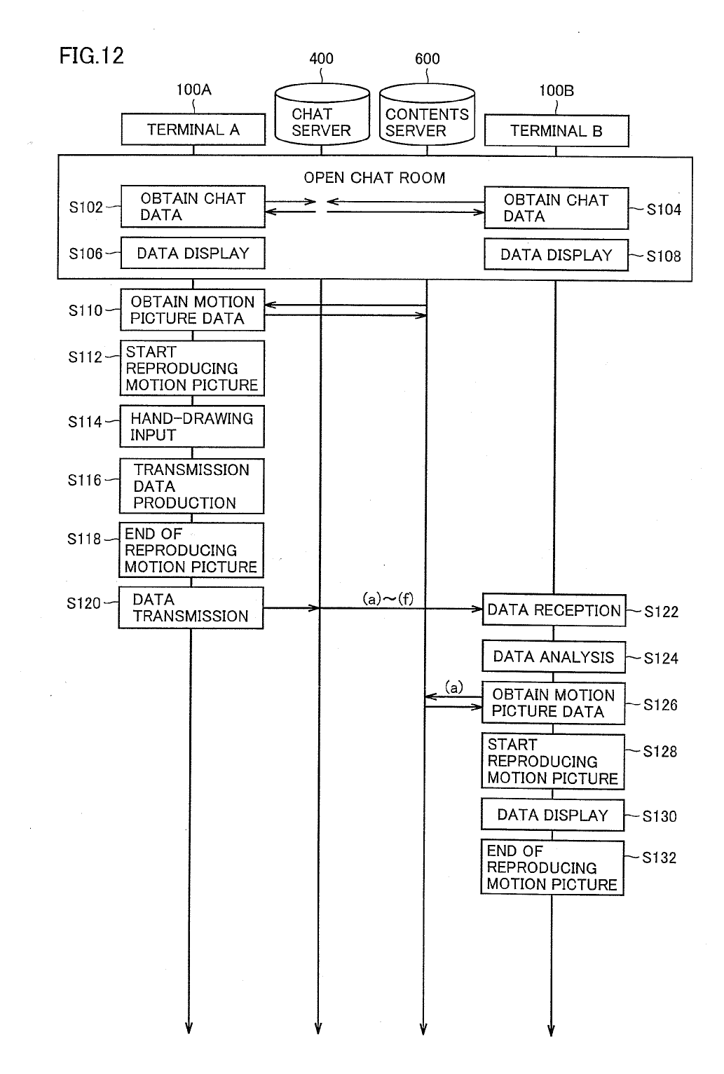

A modification of P2P communication processing at mobile phone 100 of the present embodiment will be described hereinafter. FIG. 12 is a flowchart of the procedure of a modification of P2P communication processing at mobile phone 100 of the present embodiment.

Specifically, FIG. 12 describes an example of the first communication terminal transmitting motion picture information (a) and transmission data (b)-(f) together to another communication terminal, after reproduction of motion picture contents and hand-drawing input have been ended at the first communication terminal. The description is based on the case where motion picture information and hand-drawing image are transmitted from first mobile phone 100A to second mobile phone 100B.

Referring to FIG. 12, CPU 106 of first mobile phone 100A (transmission side) obtains data associated with chat communication from chat server 400 via communication device 101 (step S102). Similarly, CPU 106 of second mobile phone 100B (recipient side) obtains data associated with chat communication from chat server 400 via communication device 101 (step S104).

As used herein, “data associated with chat communication” includes the chat room ID, member's terminal information, notification (notice information), the chat contents up to the present time, and the like.

CPU 106 of first mobile phone 100A causes touch panel 102 to display a window for chat communication (step S106). Similarly, CPU 106 of second mobile phone 100B causes touch panel 102 to display a window for chat communication (step S108).

CPU 106 of first mobile phone 100A receives motion picture contents via communication device 101 based on a contents reproduction instruction from the user (step S110). More specifically, CPU 106 receives an instruction to specify motion picture contents from the user via touch panel 102. The user may directly enter URL at first mobile phone 100A, or select a link corresponding to the desired motion picture contents on the currently displayed Web page.

As shown in FIG. 4 (a), CPU 106 of first mobile phone 100A begins to reproduce the received motion picture contents via touch panel 102 (step S112). CPU 106 may output the sound of motion picture contents via speaker 109.

It is here assumed that CPU 106 accepts hand-drawing input by a user via touch panel 102 during reproduction of the motion picture contents at first mobile phone 100A (step S114).

More specifically, CPU 106 obtains change in the touching position on touch panel 102 (trace) by sequentially accepting touch coordinate data from touch panel 102 at every predetermined time. Then, as shown in FIG. 11, CPU 106 generates transmission data including hand-drawing clear information (b), information (c) indicating the trace of the touching position, information (d) indicating the line color, information (e) indicating the line width, and timing information (f) indicating the timing of hand-drawing input (step S116).

Hand-drawing clear information (b) includes information (true) for clearing the hand-drawing input up to that time or information (false) for continuing hand-drawing input. Timing information (f) indicates the timing when hand-drawing should be effected. More specifically, timing information (f) includes the time (ms) from starting motion picture contents, information to identify a scene in the motion picture contents (scene number or the like), information to identify the frame in the motion picture contents (frame number or the like), when hand-drawing input is accepted at first mobile phone 100A.

At this stage, i.e. at step S114, CPU 106 causes display of the input hand-drawing image on the motion picture contents (overlapping on the motion picture contents) at touch panel 102 based on transmission data. As shown in FIG. 4 (b)-(d), CPU 106 causes display of a hand-drawing image at touch panel 102, according to input of the hand-drawing image.

As shown in FIG. 4 (e), every time the scene in the motion picture contents is changed, the hand-drawing image input up to that time will be cleared at first mobile phone 100A of the present embodiment. CPU 106 may transmit clear information (true) using communication device 101 at the change of a scene.

CPU 106 repeats the processing of steps S114-S116 every time input of a hand-drawing image is accepted. As shown in FIG. 4 (f), CPU 106 ends the reproduction of the motion picture contents (step S118).

CPU 106 uses communication device 101 to transmit motion picture information (a) and the already-created transmission data (b)-(f) to another communication terminal participating in the chat via chat server 400 (step S120). As shown in FIG. 11, motion picture information (a) includes, for example, the URL indicating the stored position of the motion picture.

Alternatively, CPU 106 uses communication device 101 to directly transmit motion picture information (a) and the already-created transmission data (b)-(f) to another communication terminal participating in the chat by P2P transmission (step S120). In this case, CPU 106 stores motion picture information (a) and all transmission data (b)-(f) already produced in its own memory 103.

CPU 405 of chat server 400 may leave motion picture information (a) and transmission data (b)-(f) in memory 406 for any communication terminal that may participate in the chat later on. At the current point of time, second mobile phone 100B is participating in the chat.

CPU 106 of second mobile phone 100B receives motion picture information (a) and transmission data (b)-(f) from chat server 400 via communication device 101 (step S122). CPU 106 analyzes motion picture information (a) and transmission data (b)-(f) (step S124). CPU 106 downloads the motion picture contents from contents server 600 (step S126). As shown in FIG. 4 (g), CPU 106 begins to reproduce the received motion picture contents via touch panel 102 (step S128). At this stage, CPU 106 may have the sound of the motion picture contents output via speaker 109.

As shown in FIG. 4 (h)-(j), CPU 106 causes the hand-drawing image to be drawn on the motion picture contents at touch panel 102, based on the timing information (f) of the relevant transmission data for every transmission data (step S130).

As shown in FIG. 4 (k), the hand-drawing image input up to that time will be cleared when the scene in the motion picture contents is changed, at second mobile phone 100B of the present embodiment. CPU 106 may eliminate the hand-drawing image based on clear information from first mobile phone 100A. Alternatively, CPU 106 may determine by itself that the scene has been changed, and eliminate the hand-drawing image. As shown in FIG. 4 (l), CPU 106 ends the reproduction of the motion picture contents (step S132).

Accordingly, the hand-drawing image is drawn at second mobile phone 100B, at a timing identical to that in the motion picture contents having the hand-drawing image input at first mobile phone 100A. In other words, the desired information is drawn at the scene intended by the user of first mobile phone 100A even at second mobile phone 100B.

<Input Processing at Mobile Phone 100>

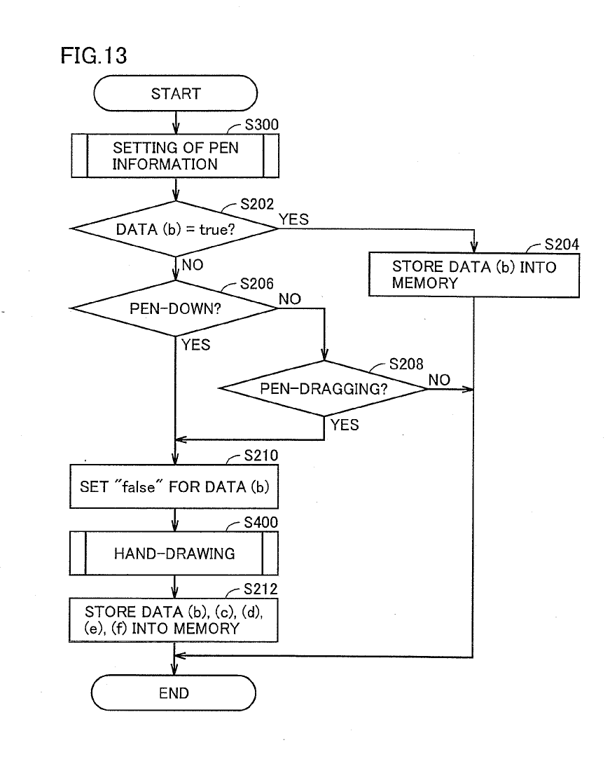

The input processing at mobile phone 100 according to the present embodiment will be described hereinafter. FIG. 13 is a flowchart of the procedure of the input processing at mobile phone 100 of the present embodiment.

Referring to FIG. 13, CPU 106 executes pen information setting processing (step S300) when input to mobile phone 100 is initiated. Pen information setting processing (step S300) will be described afterwards.

When the pen information setting process (step S300) ends, CPU 106 determines whether data (b) is true or not (step S202). When data (b) is true (YES at step S202), CPU 106 stores data (b) in memory 103 (step S204). CPU 106 ends the input processing.

When data (b) is not true (NO at step S202), CPU 106 determines whether stylus pen 120 has touched touch panel 102 or not (step S206). In other words, CPU 106 determines whether pen-down has been detected or not.

When pen-down is not detected (NO at step S206), CPU 106 determines whether the touching position of stylus pen 120 against touch panel 102 has changed or not (step S208). In other words, CPU 106 determines whether pen-dragging has been detected or not. When pen-dragging has not been detected (NO at step S208), CPU 106 ends the input processing.

When CPU 106 detects pen-down (YES at step S206), or pen-dragging (YES at step S208), CPU 106 sets “false” for data (b) (step S210). CPU 106 executes the hand-drawing processing (step S400). The hand-drawing process (step S400) will be described afterwards.

When the hand-drawing processing (step S400) ends, CPU 106 stores data (b) (c), (d), (e) and (f) in memory 103 (step S212). CPU 106 ends the input processing.

(Pen Information Setting Processing at Mobile Phone 100)

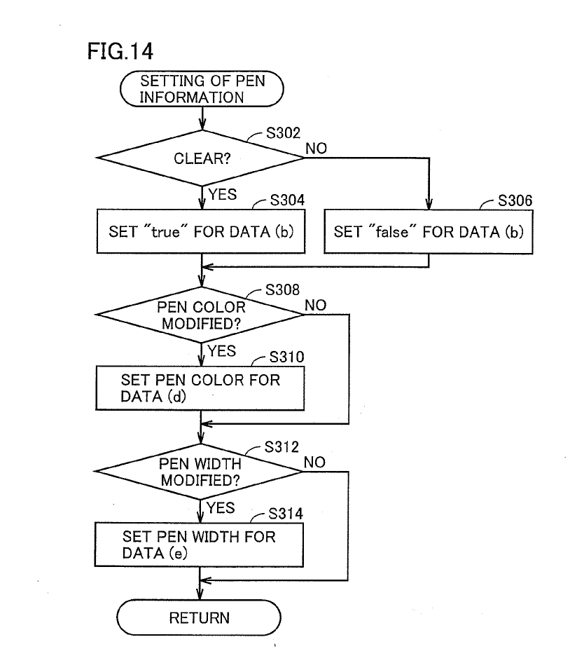

The pen information setting processing at mobile phone 100 according to the present embodiment will be described hereinafter. FIG. 14 is a flowchart of the procedure of the pen information setting processing at mobile phone 100 of the present embodiment.

Referring to FIG. 14, CPU 106 determines whether an instruction to clear the hand-drawing image has been accepted or not from the user via touch panel 102 (step S302). When an instruction to clear the hand-drawing image is accepted from the user (YES at step S302), CPU 106 sets “true” for data (b) (step S304). CPU 106 executes the processing from step S308.

When an instruction to clear the hand-drawing image has not been accepted from the user (NO at step S302), CPU 106 sets “false” for data (e) (step S306). CPU 106 determines whether an instruction to modify the color of the pen has been accepted or not from the user via touch panel 102 (step S308). When an instruction to modify the color of the pen has not been accepted from the user (NO at step S308), CPU 106 executes the process starting from step S312.

When an instruction to modify the color of the pen has been accepted from the user (YES at step S308), CPU 106 sets the modified color of the pen for data (d) (step S310). CPU 106 determines whether an instruction to modify the width of the pen has been accepted or not from the user via touch panel 102 (step S312). When an instruction to modify the width of the pen has not been accepted from the user (NO at step S312), CPU 106 ends the pen information setting processing.

When an instruction to modify the width of the pen has been accepted from the user (YES at step S312), CPU 106 sets the modified width of the pen for data (e) (step S314). CPU 106 ends the pen information setting processing.

(Hand-Drawing Processing at Mobile Phone 100)

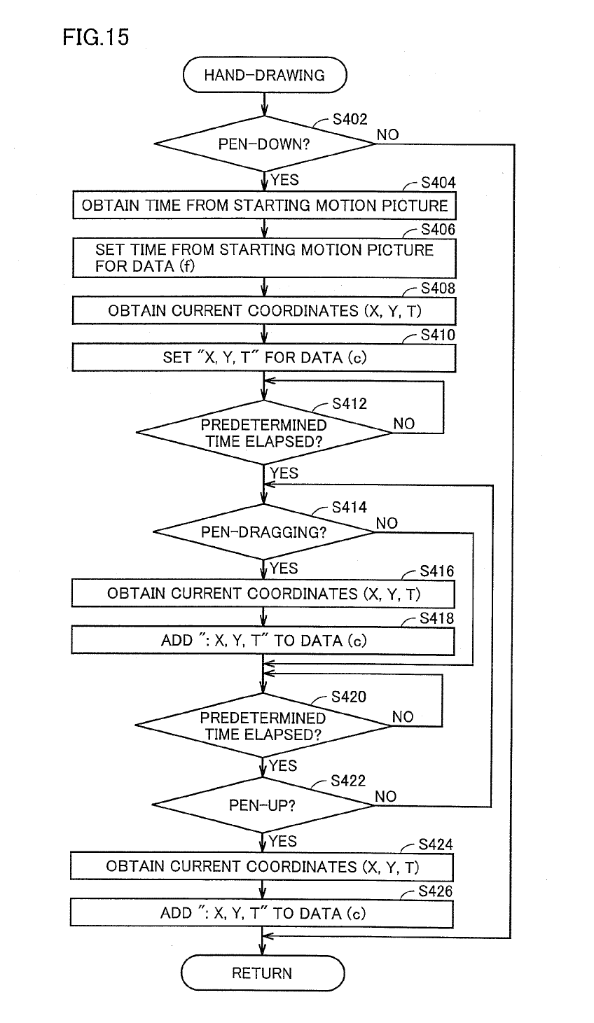

The hand-drawing processing at mobile phone 100 according to the present embodiment will be described hereinafter. FIG. 15 is a flowchart of the procedure of the hand-drawing processing at mobile phone 100 of the present embodiment.

Referring to FIG. 15, CPU 106 determines whether stylus pen 120 is currently in contact with touch panel 102 via touch panel 102 (step S402). When stylus pen 120 is not touching touch panel 102 (NO at step S402), CPU 106 ends the hand-drawing processing.

When stylus pen 120 is touching touch panel 102 (YES at step S402), CPU 106 refers to a clock not shown to obtain the elapsed time from starting the motion picture contents (step S404). CPU 106 sets the time (period) from starting motion picture contents up to starting hand-drawing input for data (f) (step S406).

In the following, CPU 106 may set information to identify a scene or information to identify a frame, instead of the time (period) from starting motion picture contents up to starting hand-drawing input. This is because the intention of the person entering the hand-drawing image can be readily conveyed if the scene is identified.

CPU 106 obtains via touch panel 102 the touching coordinates (X, Y) of stylus pen 120 on touch panel 102 and current time (T) (step S408). CPU 106 sets “X, Y, T” for data (c) (step S410).

CPU 106 determines whether a predetermined time has elapsed from the time of obtaining the previous coordinates (step S412). When the predetermined time has not elapsed (NO at step S412), CPU 106 repeats the processing from step S308.

When the predetermined time has elapsed (YES at step S412), CPU 106 determines whether pen-dragging has been detected or not by a touch panel 102 (step S414). When pen-dragging has not been detected (NO at step S414), CPU 106 executes the processing from step S420.

When pen-dragging has been detected (YES at step S414), CPU 106 obtains via touch panel 102 the touching position coordinates (X, Y) of stylus pen 120 on touch panel 102 and the current time (T) (step S416). CPU 106 adds “: X, Y, T” to data (c) (step S418). CPU 106 determines whether a predetermined time has elapsed from obtaining the previous touching coordinates (step S420). When the predetermined time has not elapsed (NO at step S420), CPU 106 skips the processing from step S420.

When the predetermined time has elapsed (YES at step S420), CPU 106 determines whether pen-up has been detected via touch panel 102 (step S422). When pen-up has not been detected (NO at step S422), CPU 106 repeats the processing from step S414.

When pen-up has been detected (YES at step S422), CPU 106 obtains via touch panel 102 the touching position coordinates (X, Y) of the stylus pen on touch panel 102 and the current time (T) (step S424). CPU 106 adds “: X, Y, T” to data (c) (step S426). CPU 106 ends the hand-drawing processing.

<Modification of Input Processing at Mobile Phone 100>

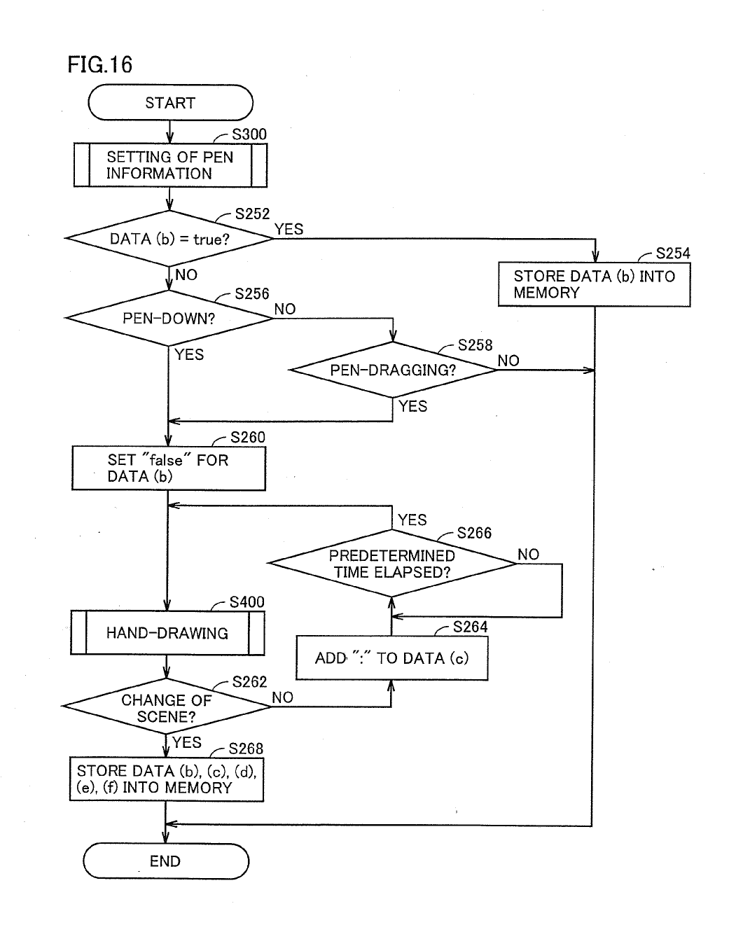

A modification of input processing at mobile phone 100 according to the present embodiment will be described hereinafter. FIG. 16 is a flowchart of the procedure of a modification of the input processing at mobile phone 100 according to the present embodiment.

Specifically, the input processing set forth above with reference to FIG. 13 relates to transmitting clear information (true) only when an instruction to clear the hand-drawing image is accepted. The input processing shown in FIG. 16 that will be described hereinafter relates to transmitting clear information (true) when an instruction to clear the hand-drawing image is accepted and when the scene in the motion picture contents has changed.

Referring to FIG. 16, CPU 106 executes the pen information setting process (step S300) set forth above when input to mobile phone 100 is initiated.

When the pen information setting processing (step S300) ends, CPU 106 determines whether data (b) is “true” or not (step S252). When data (b) is “true” (YES at step S252), CPU 106 stores data (b) in memory 103 (step S254). CPU 106 ends the input processing.

When data (b) is not true (NO at step S252), CPU 106 determines whether stylus pen 120 has touched touch panel 102 or not (step S256). In other words, CPU 106 determines whether pen-down has been detected or not.

When pen-down has not been detected (NO at step S256), CPU 106 determines whether the touching position of stylus pen 120 on touch panel 102 has changed or not (step S258). In other words, CPU 106 determines whether pen-dragging has been detected or not. When pen-dragging has not been detected (NO at step S258), CPU 106 ends the input processing.

When pen-down has been detected (YES at step S256), or when pen-dragging has been detected (YES at step S258), CPU 106 sets “false” for data (b) (step S260). CPU 106 executes the hand-drawing processing (step S400) set forth above.

When the hand-drawing processing (step S400) ends, CPU 106 determines whether the scene has been changed or not (step S262). More specifically, CPU 106 determines whether the scene when hand-drawing input has been started differs from the current scene or not. Instead of determining whether the scene has changed or not, CPU 106 may determine whether a predetermined time has elapsed from the pen-up.

When the scene has not changed (NO at step S262), CPU 106 adds “:” to data (c) (step S264). CPU 106 determines whether a predetermined time has elapsed from the previous hand-drawing processing (step S266). When the predetermined time has not elapsed (NO at step S266), CPU 106 repeats the processing from step S266. When the predetermined time has elapsed (YES at step S266), CPU 106 repeats the processing from step S400.

When the scene has changed (YES at step S262), CPU 106 stores data (b), (c), (d), (e) and (f) into memory 103 (step S268). CPU 106 ends the input processing.

<Hand-Drawing Image Display Processing at Mobile Phone 100>

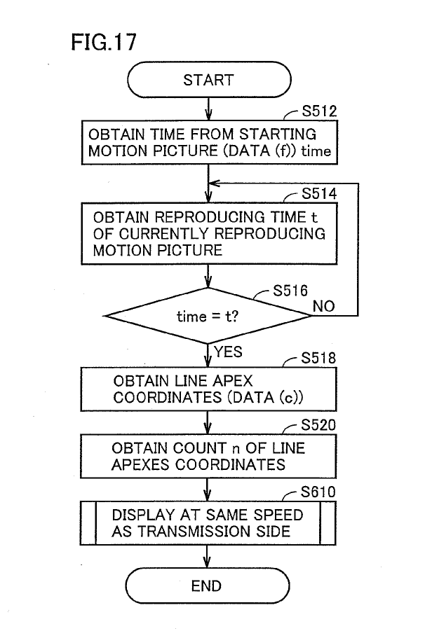

The hand-drawing image display processing at mobile phone 100 according to the present embodiment will be described hereinafter. FIG. 17 is a flowchart of the procedure of the hand-drawing image display processing at mobile phone 100 of the present embodiment. In FIG. 17, the transmission terminal at the recipient side draws a hand-drawing stroke at the same speed as the communication terminal of the transmission side.

Referring to FIG. 17, CPU 106 obtains timing information “time (f)” from the data received from another communication terminal (transmission data) (step S512). CPU 106 obtains the time (period) from starting reproduction of the motion picture contents up to the current point of time, i.e. reproducing time t of the motion picture contents (step S514).

CPU 106 determines whether time=t is established or not (step S516). When time=t is not established (NO at step S516), CPU 106 repeats the processing from step S514.

When time=t is established (YES at step S516), CPU 106 obtains the coordinates of the apex of the hand-drawing stroke (data (c)) (step S518). CPU 106 obtains the count “n” of apexes coordinates of the hand-drawing stroke (step S520).

CPU 106 executes the first drawing processing (step S610). The first drawing processing (step S610) will be described afterwards. Then, CPU 106 ends the hand-drawing image display processing.

(First Drawing Processing at Mobile Phone 100)

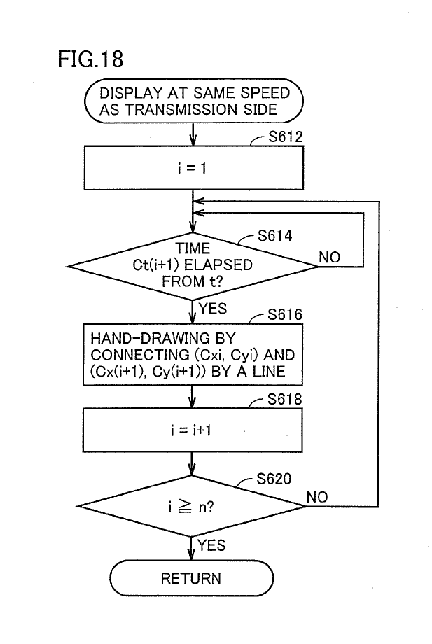

The first drawing processing at mobile phone 100 according to the present embodiment will be described hereinafter. FIG. 18 is a flowchart of the procedure of the first drawing processing at mobile phone 100 according to the present embodiment.

Referring to FIG. 18, CPU 106 inserts 1 to a variable i (step S612). CPU 106 determines whether a time of Ct (i+1) has elapsed from point of time t corresponding to the aforementioned reproducing time t (step S614). When the time Ct (i+1) has not elapsed from time t (NO at step S614), CPU 106 repeats the processing from step S614.

When the time Ct (i+1) has elapsed from time t (YES at step S614), CPU 106 uses touch panel 102 to draw a hand-drawing stroke by connecting coordinates (Cxi, Cyi) and coordinates (Cx (i+1), Cy (i+1)) by a line (step S616). CPU 106 increments variable i (step S618).

CPU 106 determines whether variable i is greater than or equal to the count n (step S620). When variable i is less than n (NO at step S620), CPU 106 repeats the processing from step S614. When variable i is greater than or equal to the count n (YES at step S620), CPU 106 ends the first drawing processing.

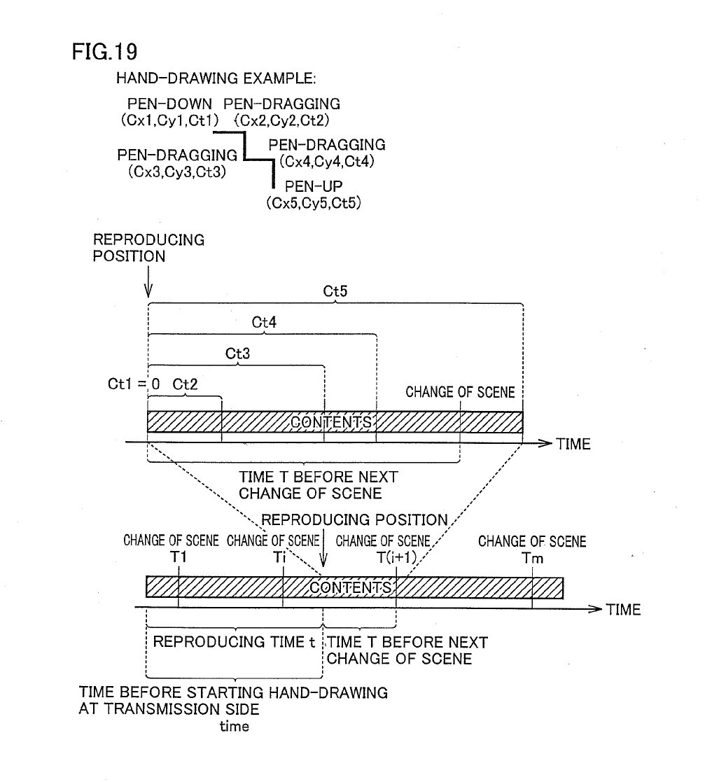

The relationship between the input and output of a hand-drawing image according to the present embodiment will be described hereinafter. FIG. 19 is a pictorial representation to describe the hand-drawing image display processing shown in FIGS. 17 and 18.

As mentioned above, CPU 106 of the communication terminal having a hand-drawing image input (first communication terminal) generates transmission data every time a hand-drawing image is input (from pen-down to pen-up), or when a clear instruction is input, or when the scene has changed. For example, when the scene changes during input of a hand-drawing image, transmission data indicating the hand-drawing image up to the point of time when the scene changes is produced.

Referring to FIG. 19, CPU 106 of the communication terminal displaying the hand-drawing image (second communication terminal) draws the hand-drawing stroke (Cx1, Cy1) to (Cx5, Cy5) based on timing information (f) and the time (Ct1) to (Ct5) corresponding to respective apexes. In other words, in the present embodiment, the communication terminal of the recipient side draws a hand-drawing stroke at the same speed as the communication terminal of the transmission side.

<First Modification of Hand-Drawing Image Display Processing at Mobile Phone 100>

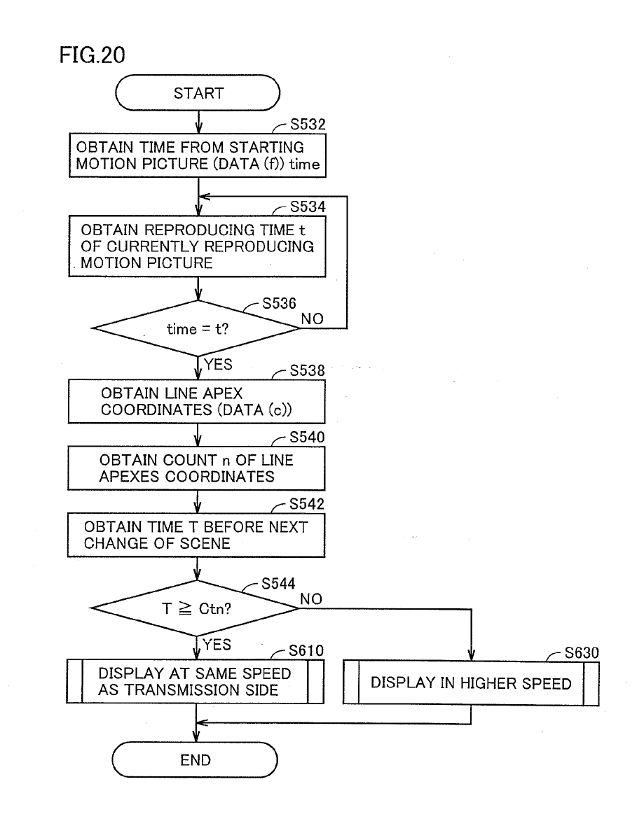

A first modification of the hand-drawing image display processing at mobile phone 100 according to the present embodiment will be described hereinafter. FIG. 20 is a flowchart of the procedure of the first modification of the hand-drawing image display processing at mobile phone 100 according to the present embodiment.

When the time required for inputting the hand-drawing image is longer than the period of time from starting hand-drawing input up to the next change of scene, the communication terminal according to the present modification can complete the drawing of the hand-drawing image before the scene is changed by shortening the drawing time. In other words, the case where input of a hand-drawing image can be continued independent of scene change (without the hand-drawing image being cleared at the change of a scene) will be described.

Referring to FIG. 20, CPU 106 obtains timing information “time (f)” from the received transmission data (step S532). CPU 106 obtains the reproducing time t of the motion picture contents (period of time that starts from the point of time when the motion picture contents is started up to the current time) (step S534).

CPU 106 determines whether time=t is established or not (step S536). When time=t is not established (NO at step S536), CPU 106 repeats the processing from step S534.

When time=t is established (YES at step S536), CPU 106 obtains the coordinates of the apex of the hand-drawing stroke (data (c)) (step S538). CPU 106 obtains the count “n” of apexes coordinates of the hand-drawing stroke (step S540).

CPU 106 refers to the motion picture contents to obtain the time T before the next change of scene from timing information “time” (step S542). CPU 106 determines whether time T is greater than or equal to the time Ct×n between apexes (step S544).

When time T is greater than or equal to the time Ct×n between apexes (YES at step S544), CPU 106 executes the first drawing processing (step S610) set forth above. CPU 106 ends the hand-drawing image display processing. This corresponds to the case where clear information is input prior to a change of scene or when a predetermined time has elapsed from pen-up before a change of scene.

When time T is less than time Ct×n between apexes (NO at step S544), CPU 106 executes the second drawing processing (step S630). The second drawing processing (step S630) will be described afterwards. Then, CPU 106 ends the hand-drawing image display processing. This corresponds to the case where a change of scene has occurred during input of a hand-drawing image.

(Second Drawing Processing at Mobile Phone 100)

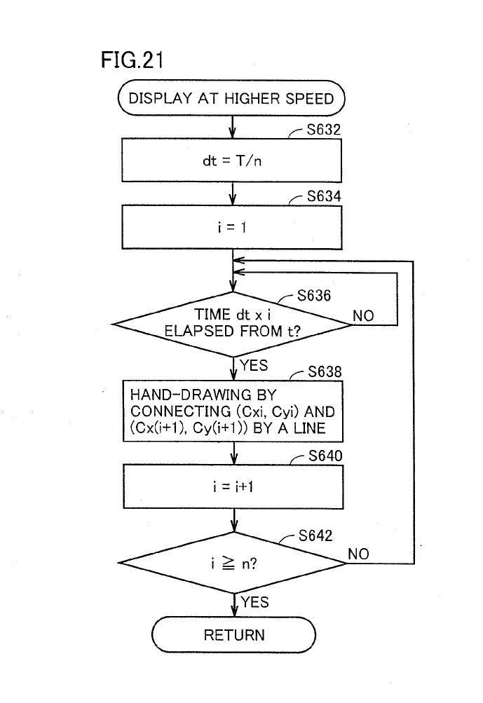

The second drawing processing at mobile phone 100 according to the present embodiment will be described hereinafter. FIG. 21 is a flowchart of the procedure of the second drawing processing at mobile phone 100 of the present embodiment. As set forth above, the case where a change of scene has occurred during input of a hand-drawing image will be described, as mentioned above.

Referring to FIG. 21, CPU 106 enters T/n into a variable dt (step S632). Variable dt is the time between apexes in the drawing mode, and is smaller than time Ct between apexes during input.

CPU 106 enters 1 to variable i (step S634). CPU 106 determines whether time dt×i has elapsed from time t (step S636). When the time dt×i has not elapsed from time t (NO at step S636), CPU 106 repeats the processing from step S636.

When the time dt×i has elapsed from time t (YES at step S636), CPU 106 uses touch panel 102 to draw a hand-drawing stroke by connecting coordinates (Cxi, Cyi) and coordinates (Cx (i+1), Cy (i+1)) by a line (step S638). CPU 106 increments variable i (step S640).

CPU 106 determines whether variable i is greater than or equal to the count n (step S642). When variable i is less than n (NO at step S642), CPU 106 repeats the processing from step S636. When variable i is greater than or equal to the count n (YES at step S642), CPU 106 ends the second drawing processing.

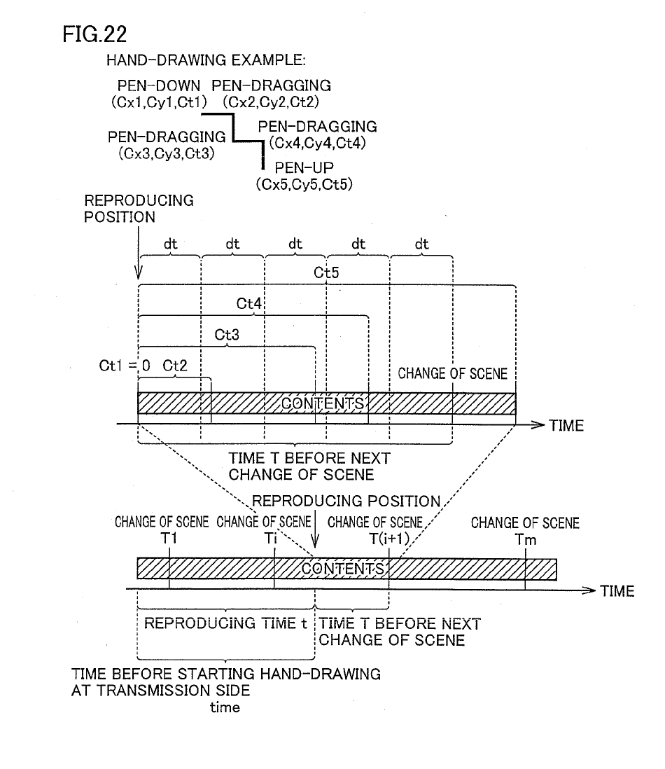

The relationship between the input and output of a hand-drawing image according to the present modification will be described hereinafter. FIG. 22 is a pictorial representation to describe the hand-drawing image display processing shown in FIGS. 20 and 21.

As mentioned above, CPU 106 of the communication terminal having a hand-drawing image input (first communication terminal) generates transmission data every time a hand-drawing image is input (from pen-down to pen-up), or when a clear instruction is input in the present modification.

Referring to FIG. 22, CPU 106 of the communication terminal displaying the hand-drawing image (second communication terminal) draws the hand-drawing stroke (Cx1, Cy1) to (Cx5, Cy5) based on timing information (f) and the time dt corresponding to two apexes. Therefore, when the time required for inputting the hand-drawing image is longer than the period of time from starting hand-drawing input up to the next change of scene, the communication terminal of the present modification can complete the drawing of the hand-drawing image before the scene is changed by shortening the drawing time. In other words, even in the case where the user of the transmission side inputs a hand-drawing image spanning a plurality of scenes, the communication terminal of the recipient side can complete the drawing of the hand-drawing image within the intended scene.

<Second Modification of Hand-Drawing Image Display Processing at Mobile Phone 100>

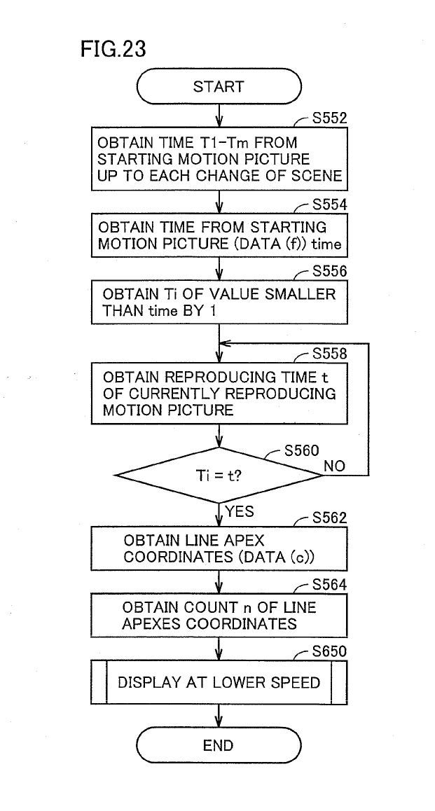

A second modification of hand-drawing image processing at mobile phone 100 according to the present embodiment will be described. FIG. 23 is a flowchart of the procedure of a second modification of the hand-drawing image display processing at mobile phone 100 of the present embodiment. The communication terminal of the present modification draws the hand-drawing image over the entire period of the scene in which the point of time when input of a hand-drawing image is started is included.

Referring to FIG. 23, CPU 106 refers to the motion picture contents to obtain a period of time (length) T1-Tm from starting reproducing the motion picture contents up to the next change of scene (step S552). In other words, CPU 106 obtains the time starting from the reproduction of motion picture contents until the end of each scene. CPU 106 obtains timing information “time (f)” from the received transmission data (step S554).

CPU 106 obtains time T1 that starts from starting reproducing the motion picture contents up to the change of scene immediately previous to the scene corresponding to timing information “time” (step S556). In other words, the scene corresponding to timing information “time” is identified, and a length Ti that starts from starting reproducing the motion picture contents until the ending point of time of the scene immediately previous to the relevant scene is obtained. CPU 106 obtains a reproducing time t of the motion picture contents (a period of time that starts from the point of time when the motion picture contents is started up to the current time) (step S558).

CPU 106 determines whether Ti=t is established or not (step S560). When Ti=t is not established (NO at step S560), CPU 106 repeats the processing from step S558.

When Ti=t is established (YES at step S560), CPU 106 obtains the coordinates of the apex of the hand-drawing stroke (data (c)) (step S562). CPU 106 obtains the count “n” of the apexes coordinates of the hand-drawing stroke (step S564).

CPU 106 executes the third drawing processing (step S650). The third drawing processing (step S650) will be described afterwards. Then, CPU 106 ends the hand-drawing image display processing.

(Third Drawing Processing at Mobile Phone 100)

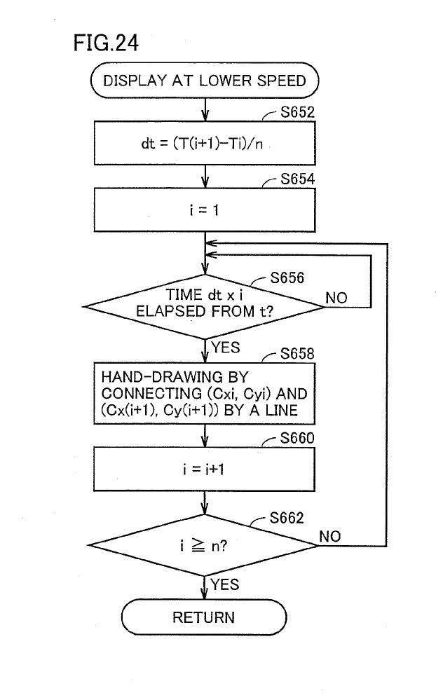

The third drawing processing at mobile phone 100 according to the present embodiment will be described hereinafter. FIG. 24 is a flowchart of the procedure of the third drawing processing at mobile phone 100 according to the present embodiment.

Referring to FIG. 24, CPU 106 inserts (T (i+1)−Ti)/n into variable dt (step S652). Variable dt is a value of the scene in which a hand-drawing image is input divided by the number of apexes.

CPU 106 inserts 1 to a variable i (step S654). CPU 106 determines whether a time dt×i has elapsed from the reproducing time (time t) (step S656). When time dt×i has not elapsed from time t (NO at step S656), CPU 106 repeats the processing from step S656.

When time dt×i has elapsed from time t (YES at step S656), CPU 106 uses touch panel 102 to draw a hand-drawing stroke by connecting coordinates (Cxi, Cyi) and coordinates (Cx (i+1), Cy (i+1)) by a line (step S658). CPU 106 increments variable i (step S660).

CPU 106 determines whether variable i is greater than or equal to the count n (step S662). When variable i is less than n (NO at step S662), CPU 106 repeats the processing from step S656. When variable i is greater than or equal to the count n (YES at step S662), CPU 106 ends the third drawing processing.

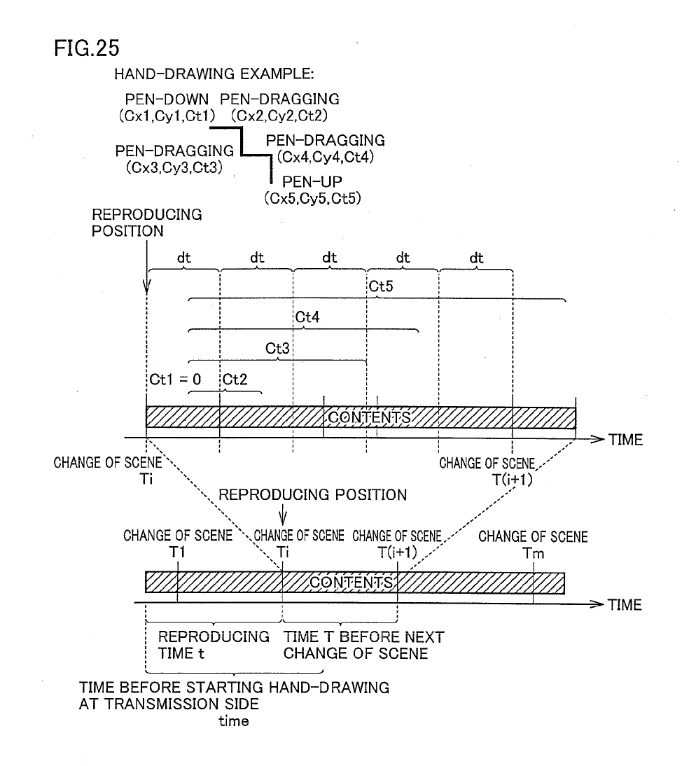

The relationship between the input and output of a hand-drawing image according to the present embodiment will be described hereinafter. FIG. 25 is a pictorial representation to describe the hand-drawing image display processing shown in FIGS. 23 and 24.

As mentioned above, CPU 106 of the communication terminal having a hand-drawing image input (first communication terminal) generates transmission data every time a hand-drawing image is input (from pen-down to pen-up), or when a clear instruction is input.

Referring to FIG. 25, CPU 106 of the communication terminal displaying the hand-drawing image (second communication terminal) draws the hand-drawing stroke (Cx1, Cy1) to (Cx5, Cy5) based on timing information (f) and the time dt corresponding to two apexes. In other words, the communication terminal according to the present modification sets the input speed of the hand-drawing image as slow as possible in accordance with the length of the scene corresponding to the hand-drawing image. The communication terminal can complete drawing the hand-drawing image before the change of scene.

Even if the user of the transmission side enters a hand-drawing image spanning a plurality of scenes, the communication terminal of the recipient side can complete drawing the hand-drawing image sufficiently within the scene intended by the user of the transmission side. In other words, the communication terminal of the recipient side will begin to draw the hand-drawing image at a timing earlier than the point of time when input of a hand-drawing image is started at the communication terminal of the transmission side, i.e. from the point of time of starting the scene to which the point of time when input of the hand-drawing image is started belongs to.

### Second Embodiment

A second embodiment of the present invention will be described hereinafter. Network system 1 according to the first embodiment set forth above has the motion picture contents reproduced at a different timing between each of the communication terminals (first mobile phone 100A, second mobile phone 100B, third mobile phone 100C, and fourth mobile phone 100D). In contrast, network system 1 of the present embodiment effectively conveys the intention of a user transmitting (entering) information to the user receiving (viewing) the information by having each communication terminal start reproducing the motion picture contents at the same time.

Elements similar to those of network system 1 of the first embodiment have the same reference number allotted. Their functions are also identical. Therefore, description of such constituent elements will not be repeated. For example, the overall configuration of network system 1, the overall operation overview of network system 1, the hardware configuration of mobile phone 100, chat server 400, and contents server 600, and the like are similar to those of the first embodiment. Therefore, description thereof will not be repeated.

<Communication Processing at Mobile Phone 100>

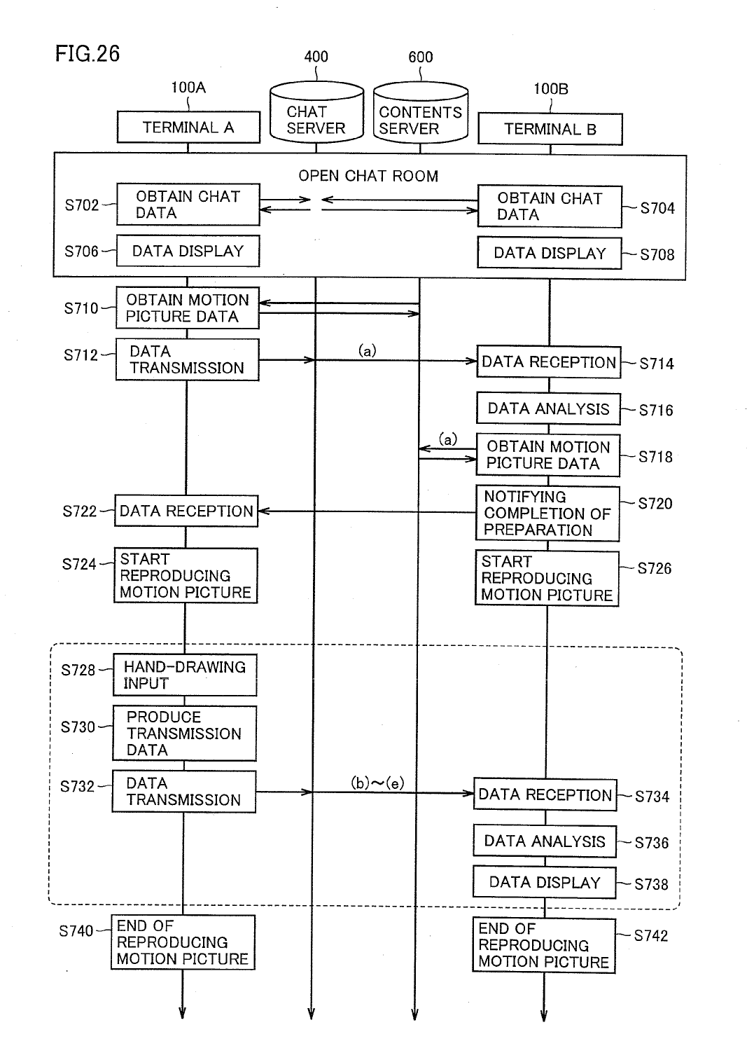

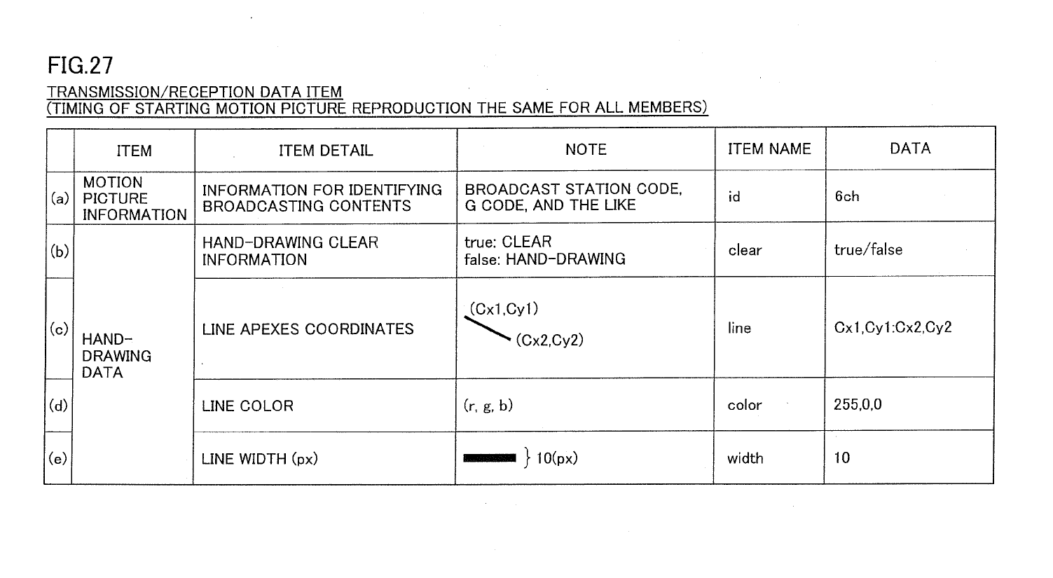

P2P communication processing at mobile phone 100 of the present embodiment will be described hereinafter. FIG. 26 is a flowchart of the procedure of P2P communication processing at mobile phone 100 of the present embodiment. FIG. 27 is a pictorial representation of the data structure of transmission data according to the present embodiment.

The following description is based on the case where first mobile phone 100A transmits a hand-drawing image to second mobile phone 100B. In the present embodiment, first mobile phone 100A and second mobile phone 100B transmit/receive data via chat server 400. However, data may be transmitted/received through P2P communication without the intervention of chat server 400. In this case, first mobile phone 100A must store data or transmit data to second mobile phone 100B or third mobile phone 100C, on behalf of chat server 400.

Referring to FIG. 26, CPU 106 of first mobile phone 100A (transmission side) obtains data associated with chat communication from chat server 400 via communication device 101 (step S702). Similarly, CPU 106 of second mobile phone 100B (recipient side) obtains data associated with chat communication from chat server 400 via communication device 101 (step S704).

As used herein “data associated with chat communication” includes the chat room ID, member's terminal information, notification (notice information), the chat contents up to the present time, and the like.

CPU 106 of first mobile phone 100A causes touch panel 102 to display a window for chat communication (step S706). Similarly, CPU 106 of second mobile phone 100B causes touch panel 102 to display a window for chat communication (step S708).

CPU 106 of first mobile phone 100A receives motion picture contents via communication device 101 based on a contents reproduction instruction from the user (step S710). More specifically, CPU 106 receives an instruction to specify motion picture contents from the user via touch panel 102. The user may directly enter URL at first mobile phone 100A, or select a link corresponding to the desired motion picture contents on the currently displayed Web page.

CPU 106 of first mobile phone 100A uses communication device 101 to transmit motion picture information (a) for identifying selected motion picture contents to another communication terminal participating in the chat via chat server 400 (step S712). As shown in FIG. 27, motion picture information (a) includes, for example, the URL indicating the stored location of the motion picture contents. CPU 405 of chat server 400 stores motion picture information (a) in memory 406 for any communication terminal subsequently participating in the chat.

CPU 106 of second mobile phone 100B receives motion picture information (a) from chat server 400 via communication device 101 (step S714). CPU 106 analyzes the motion picture information (step S716), and downloads the motion picture contents from contents server 600 (step S718).

CPU 106 transmits a message to first mobile phone 100A informing that preparation of reproducing motion picture contents has been completed via communication device 101 (step S720). CPU 106 of first mobile phone 100A receives that message from second mobile phone 100B via communication device 101 (step S722).

CPU 106 of first mobile phone 100A begins to reproduce the received motion picture contents via touch panel 102 (step S724). CPU 106 may output the sound of motion picture contents via speaker 109. Similarly, CPU 106 of second mobile phone 100B begins to reproduce the received motion picture contents via touch panel 102 (step S726). At this stage, CPU 106 may have the sound of the motion picture contents output via speaker 109.

It is here assumed that CPU 106 accepts hand-drawing input by a user via touch panel 102 during reproduction of the motion picture contents at first mobile phone 100A (step S728).

More specifically, CPU 106 obtains change in the touching position on touch panel 102 (trace) by sequentially accepting touch coordinate data from touch panel 102 at every predetermined time. At this stage, i.e. at step S728, CPU 106 causes display of the input hand-drawing image on the motion picture contents (overlapping on the motion picture contents) at touch panel 102. CPU 106 causes display of a hand-drawing image at touch panel 102 according to input of the hand-drawing image.

Then, as shown in FIG. 27, CPU 106 generates transmission data including hand-drawing clear information (b), information (c) indicating the trace of the touching position, information (d) indicating the line color, and information (e) indicating the line width (step S730). Hand-drawing clear information (b) includes information (true) for clearing the hand-drawing input up to that time or information (false) for continuing hand-drawing input. Information (c) indicating the trace of the touching position includes the coordinates of each apex constituting a hand-drawing stroke, and the elapsed time from the point of time when hand-drawing input corresponding to each apex is started.

CPU 106 of first mobile phone 100A uses communication device 101 to transmit transmission data to second mobile phone 100B via chat server 400 (step S732). CPU 106 of second mobile phone 100B receives the transmission data from first mobile phone 100A via communication device 101 (step S734).

CPU 106 of second mobile phone 100B analyzes the transmission data (step S736). CPU 106 of second mobile phone 100B causes display of a hand-drawing image at touch panel 102 based on the analyzed result (step S738).

Every time a scene in the motion picture contents is changed, the hand-drawing image input up to that time will be cleared at first mobile phone 100A of the present embodiment. CPU 106 may transmit clear information (true) using communication device 101 at the change of a scene. CPU 106 of second mobile phone 100B may eliminate the hand-drawing image based on clear information from first mobile phone 100A. Alternatively, CPU 106 may determine by itself that the scene has been changed, and eliminate the hand-drawing image.

CPU 106 of first mobile phone 100A repeats the processing from step S728 to step S732 every time input of hand-drawing is accepted. By contrast, CPU 106 of second mobile phone 100B repeats the processing from step S734—step S738 every time transmission data is received.

CPU 106 of first mobile phone 100A ends the reproduction of the motion picture contents (step S740). CPU 106 of second mobile phone 100B ends the reproduction of the motion picture contents (step S742).

Accordingly, the hand-drawing image is drawn at second mobile phone 100B, at a timing identical to that in the motion picture contents having the hand-drawing image input at first mobile phone 100A. In other words, at second mobile phone 100B, the desired information is drawn at the scene intended by the user of first mobile phone 100A.

<Input Processing at Mobile Phone 100>

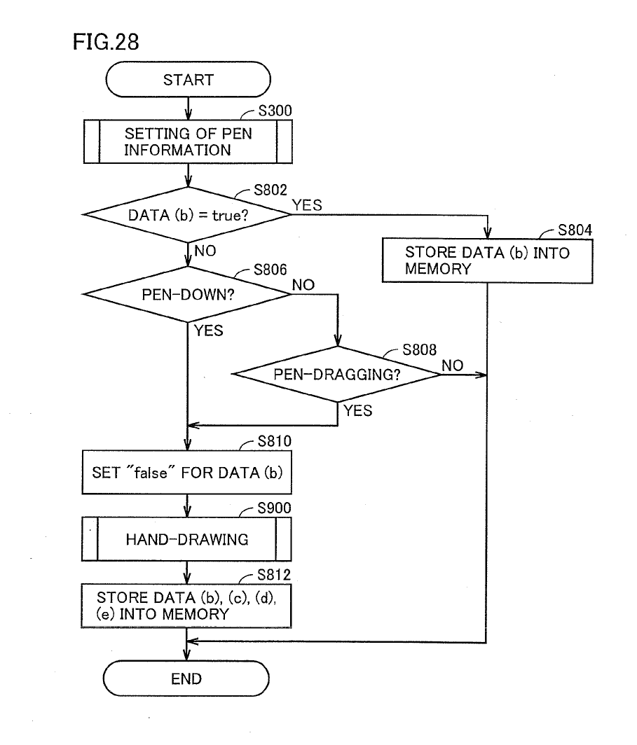

The input processing at mobile phone 100 according to the present embodiment will be described hereinafter. FIG. 28 is a flowchart of the procedure of the input processing at mobile phone 100 of the present embodiment.

Referring to FIG. 28, CPU 106 executes the aforementioned pen information setting processing (step S300) when input to mobile phone 100 is initiated. Pen information setting processing (step S300) will be described afterwards.

When the pen information setting process (step S300) ends, CPU 106 determines whether data (b) is true or not (step S802). When data (b) is true (YES at step S802), CPU 106 stores data (b) in memory 103 (step S804). CPU 106 ends the input processing.

When data (b) is not true (NO at step S802), CPU 106 determines whether stylus pen 120 has touched touch panel 102 or not (step S806). In other words, CPU 106 determines whether pen-down has been detected or not.

When pen-down is not detected (NO at step S806), CPU 106 determines whether the touching position of stylus pen 120 against touch panel 102 has changed or not (step S808). In other words, CPU 106 determines whether pen-dragging has been detected or not. When pen-dragging has not been detected (NO at step S808), CPU 106 ends the input processing.

When CPU 106 detects pen-down (YES at step S806), or pen-dragging (YES at step S808), CPU 106 sets data (b) at “false” (step S810). CPU 106 executes the hand-drawing processing (step S900). The hand-drawing process (step S900) will be described afterwards.

When the hand-drawing processing (step S900) ends, CPU 106 stores data (b) (c), (d), and (e) in memory 103 (step S812). CPU 106 ends the input processing.

(Hand-Drawing Processing at Mobile Phone 100)

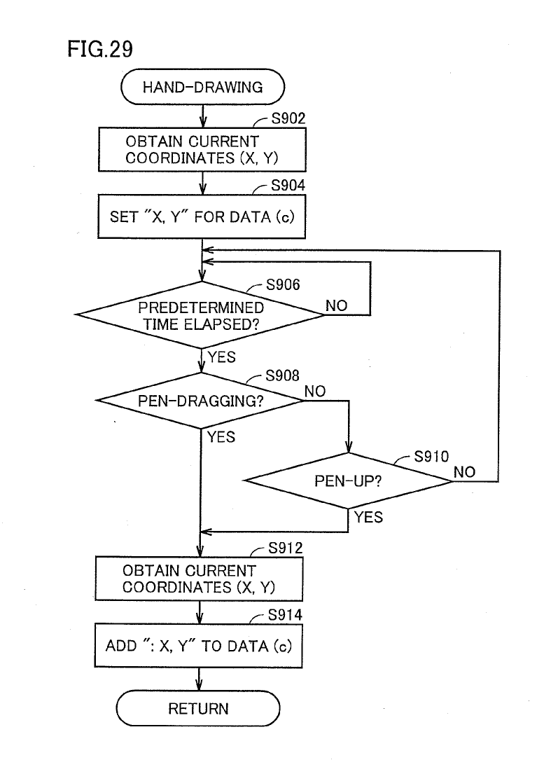

The hand-drawing processing at mobile phone 100 according to the present embodiment will be described hereinafter. FIG. 29 is a flowchart of the procedure of the hand-drawing processing at mobile phone 100 of the present embodiment.

Referring to FIG. 29, CPU 106 obtains via touch panel 102 the touching coordinate (X, Y) of stylus pen 120 on touch panel 102 (step S902). CPU 106 sets “X, Y” for data (c) (step S904).

CPU 106 determines whether a predetermined time has elapsed from obtaining the previous coordinates (step S906). When the predetermined time has not elapsed (NO at step S906), CPU 106 repeats the processing from step S906.

When the predetermined time has elapsed (YES at step S906), CPU 106 determines whether pen-dragging has been detected or not via touch panel 102 (step S908). When pen-dragging has not been detected (NO at step S908), CPU 106 determines whether pen-up has been detected or not via touch panel 102 (step S910). When pen-up has not been detected (NO at step S910), CPU 106 repeats the processing from step S906.

When pen-dragging has been detected (YES at step S908) or when pen-up has been detected (YES at step S910), CPU 106 obtains via touch panel 102 the touching position coordinates (X, Y) of stylus pen 120 on touch panel 102 (step S912). CPU 106 adds “: X, Y” to data (c) (step S914). CPU 106 ends the hand-drawing processing.

<Display Processing at Mobile Phone 100>

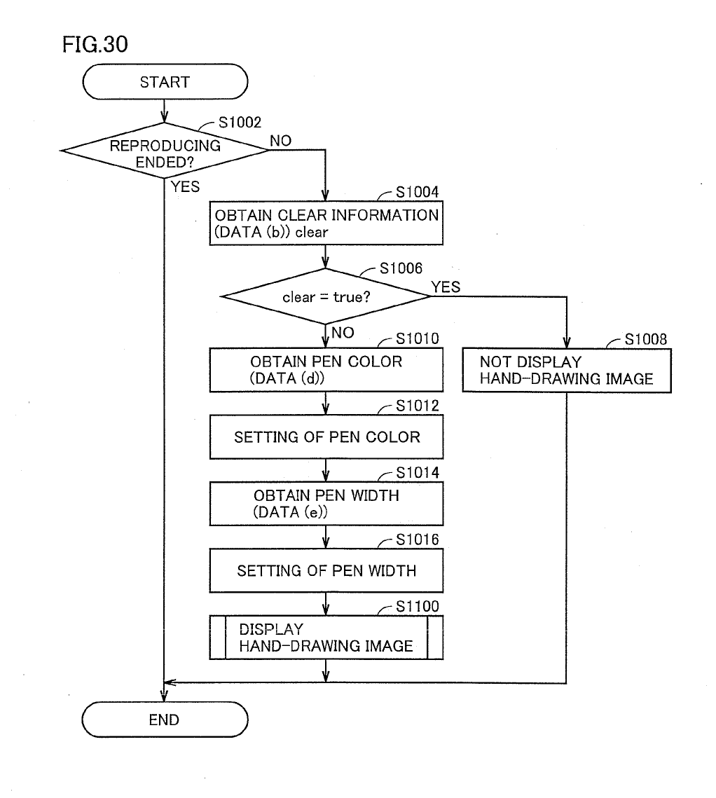

Display processing at mobile phone 100 according to the present embodiment will be described hereinafter. FIG. 30 is a flowchart of the procedure of the display processing at mobile phone 100 of the present embodiment.

Referring to FIG. 30, CPU 106 determines whether reproduction of the motion picture contents has ended or not (step S1002). When reproduction of the motion picture contents has ended (YES at step S1002), CPU 106 ends the display processing.

When the reproduction of the motion picture contents has not ended (NO at step S1002), CPU 106 obtains clear information “clear” (data (b)) (step S1004). CPU 106 determines whether clear information “clear” is “true” or not (step S1006). When clear information “clear” is “true” (YES at step S1006), CPU 106 sets the hand-drawing image at “not display” (step S1008). CPU 106 ends the display processing.

When clear information “clear” is not “true” (NO at step S1006), CPU 106 obtains the color of the pen (data (d)) (step S1010). CPU 106 resets the color of the pen (step S1012). CPU 106 obtains the width of the pen (data (e)) (step S1014). CPU 106 resets the width of the pen (step S1016). Then, CPU 106 executes the hand-drawing image display processing (step S1100). The hand-drawing image display processing (step S1100) will be described afterwards. CPU 106 ends the display processing.

<Exemplary Application of Display Processing at Mobile Phone 100>

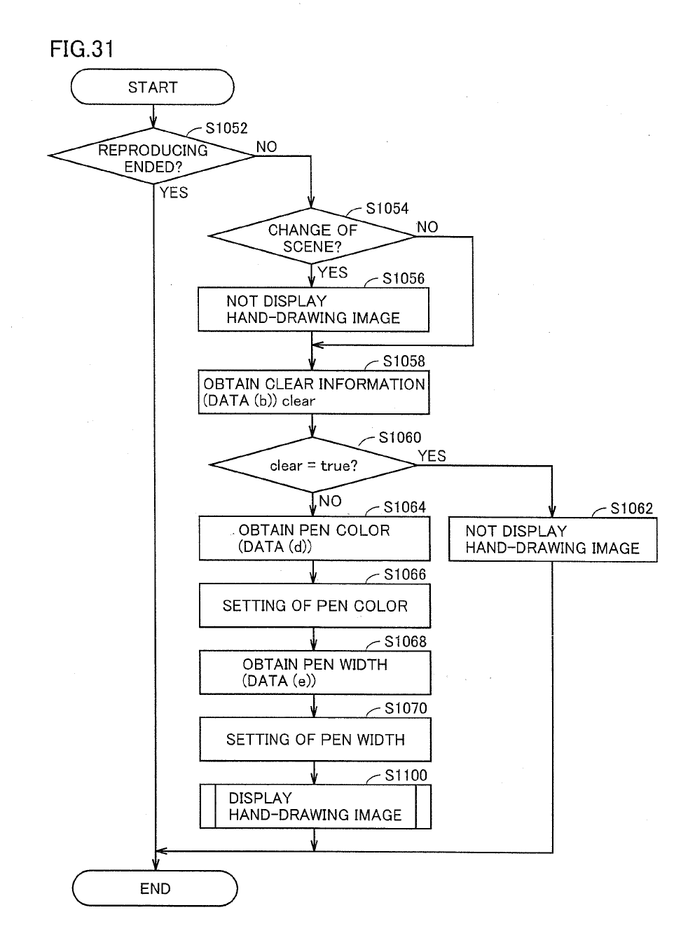

An exemplary application of display processing at mobile phone 100 according to the present embodiment will be described hereinafter. FIG. 31 is a flowchart of the procedure of an application of display processing at mobile phone 100 according to the present embodiment. This application is directed to eliminating (resetting) the hand-drawing image displayed up to that time when the scene has changed in addition to clear information.

Referring to FIG. 31, CPU 106 determines whether reproduction of the motion picture contents has ended or not (step S1052). When reproduction of the motion picture contents has ended (YES at step S1052), CPU 106 ends the display processing.

When reproduction of the motion picture contents has not ended (NO at step S1052), CPU 106 determines whether the scene of motion picture contents has changed or not (step S1054). When the scene of the motion picture contents has not changed (NO at step S1054), CPU 106 executes the processing from step S1058.

When the scene of the motion picture contents has been changed (YES at step S1054), CPU 106 sets the hand-drawing image that has been displayed up to that time at “not-display” (step S1056). CPU 106 obtains clear information “clear” (data (b)) (step S1058). CPU 106 determines whether clear information “clear” is “true” or not (step S1060). When clear information clear is true “true” (YES at step S1060), CPU 106 sets the hand-drawing image that has been displayed up to that time at “not-display” (step S1062). CPU 106 ends the display processing.

When clear information “clear” is not “true” (NO at step S1060), CPU 106 obtains the color of the pen (data (d)) (step S1064). CPU 106 resets the color of the pen (step S1066). CPU 106 obtains the width of the pen (data (e)) (step S1068). CPU 106 resets the width of the pen (step S1070). Then, CPU 106 executes the hand-drawing image display processing (step S1100). The hand-drawing image display processing (step S1100) will be described afterwards. CPU 106 ends the display processing.

<Hand-Drawing Image Display Processing at Mobile Phone 100>

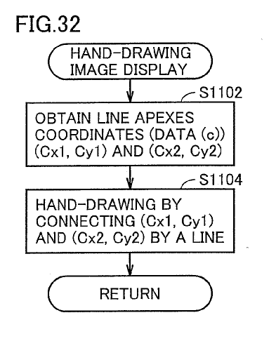

A hand-drawing image display processing at mobile phone 100 according to the present embodiment will be described hereinafter. FIG. 32 is a flowchart of the procedure of hand-drawing image display processing at mobile phone 100 according to the present embodiment

Referring to FIG. 32, CPU 106 obtains the coordinates (data (c)) of the apexes of the hand-drawing stroke (step S1102). At this stage, CPU 106 obtains the latest two coordinates, i.e. coordinates (Cx1, Cy1) and coordinates (Cx2, Cy2). CPU 106 draws a hand-drawing stroke by connecting coordinates (Cx1, Cy1) and coordinates (Cx2, Cy2) by a line (step S1104). CPU 106 ends the hand-drawing image display processing.

<Another Application of Network System>

The present invention can also be applied to the case where the present invention is achieved by supplying a program to a system or device. The advantage of the present invention can be enjoyed by supplying a storage medium in which is stored the program represented by software for achieving the present invention to a system or device, and a computer (or CPU or MPU) of that system or device reading out and executing the program codes stored in the storage medium.

In this case, the program codes per se read out from the storage medium will implement the function of the embodiments set forth above, and the storage medium storing the programs codes will constitute the present invention.

For a storage medium to supply the program code, a hard disk, optical disk, magneto optical disk, CD-ROM, CD-R, magnetic tape, non-volatile memory card (IC memory card), ROM (mask ROM, flash EEPROM and the like), for example, may be used.

In addition to realizing the functions of the embodiments set forth above by executing program codes read out by a computer, the functions of the embodiments described above may be realized by a process according to an OS (Operating System) running on the computer performing a part of or all of the actual process, based on the commands of the relevant program codes.

Further, the program codes read out from a storage medium may be written to a memory included in a functionality expansion board inserted to a computer or a functionality expansion unit connected to a computer. Then, the functions of the embodiments described above may be realized by a process according to a CPU or the like provided on the functionality expansion board or the functionality expansion unit, performing a part of or all of the actual process, based on the commands of the relevant program codes.

It is to be understood that the embodiments disclosed herein are only by way of example, and not to be taken by way of limitation. The scope of the present invention is not limited by the description above, but rather by the terms of the appended claims, and is intended to include any modifications within the scope and meaning equivalent to the terms of the claims.

### REFERENCE SIGNS LIST

1 network system; 100, 100A, 100B, 100C, 100D mobile phone; 101 communication device; 102 touch panel; 103 memory; 103A work memory; 103B address book data; 103C self-terminal data; 103D address data; 103E address data; 104 pen tablet; 106 CPU; 107 display; 108 microphone; 109 speaker; 110 various-type button; 111 first notification unit; 112 second notification unit; 113 TV antenna; 120 stylus pen; 200 car navigation device; 250 vehicle; 300 personal computer; 400 chat server; 406 memory; 406A room management table; 407 hard disk; 408 internal bus; 409 communication device; 500 Internet; 600 contents server; 606 memory; 607 hard disk; 608 internal bus; 609 communication device; 615 hard disk; 700 carrier network.

1. A network system comprising first and second communication terminals,
said first communication terminal including:
a first communication device for communicating with said second communication terminal;
a first touch panel for displaying motion picture contents; and
a first processor for accepting input of a hand-drawing image via said first touch panel,
said first processor transmitting said hand-drawing image input during display of said motion picture contents and start information for identifying a point of time when input of said hand-drawing image at the motion picture contents is started to said second communication terminal via said first communication device,
said second communication terminal including:
a second touch panel for displaying said motion picture contents;
a second communication device for receiving said hand-drawing image and said start information from said first communication terminal; and
a second processor for displaying said hand-drawing image from said point of time when input of said hand-drawing image at said motion picture contents is started on said second touch panel, based on said start information.

2. The network system according to claim 1, further comprising a contents server for distributing said motion picture contents, wherein
said first processor is configured to
obtain said motion picture contents from said contents server according to a download instruction, and
transmit motion picture information for identifying said motion picture contents obtained to said second communication terminal via said first communication device, and
said second processor is configured to obtain said motion picture contents from said contents server based on said motion picture information.

3. The network system according to claim 1, wherein said first processor transmits, via said first communication device, an instruction to eliminate said hand-drawing image to said second communication terminal when a scene of said motion picture contents has changed and/or when an instruction to clear said input hand-drawing image is accepted.

4. The network system according to claim 1, wherein said second processor
calculates a time starting from said point of time when input is started up to the point of time when a scene in said motion picture contents is changed, and
determines a drawing speed of said hand-drawing image on said second touch panel based on said time.

5. The network system according to claim 1, wherein said second processor
calculates a length of a scene in said motion picture contents including said point of time when input is started, and
determines a drawing speed of said hand-drawing image on said second touch panel based on said length.

6. A communication method at a network system including first and second communication terminals capable of communication with each other, comprising the steps of:
displaying, by said first communication terminal, motion picture contents;
accepting, by said first communication terminal, input of a hand-drawing image;
transmitting, by said first communication terminal, to said second communication terminal said hand-drawing image input during display of said motion picture contents and start information for identifying a point of time when input of said hand-drawing image at said motion picture contents is started;
displaying, by said second communication terminal, said motion picture contents;
receiving, by said second communication terminal, said hand-drawing image and said start information from said first communication terminal; and
displaying, by said second communication terminal, said hand-drawing image from said point of time when input of said hand-drawing image at said motion picture contents is started, based on said start information.

7. A communication terminal capable of communicating with an other communication terminal, comprising:
a communication device for communicating with said other communication terminal;
a touch panel for displaying motion picture contents;
a processor for accepting input of a first hand-drawing image via said touch panel, said processor configured to
transmit said first hand-drawing image input during display of said motion picture contents, and first start information for identifying a point of time when input of said first hand-drawing image at said motion picture contents is started to said other communication terminal via said communication device,
receive a second hand-drawing image and second start information from said other communication terminal, and
cause display of said second hand-drawing image from the point of time when input of said second hand-drawing image at said motion picture contents is started on said touch panel, based on said second start information.

8. A communication method at a communication terminal including a communication device, a touch panel, and a processor, comprising the steps of:
causing, by said processor, display of motion picture contents at said touch panel;
accepting, by said processor, input of a first hand-drawing image via said touch panel;
transmitting, by said processor, said first hand-drawing image input during display of the motion picture contents and start information for identifying a point of time when input of said first hand-drawing image at said motion picture contents is started to an other communication terminal via said communication device;
receiving, by said processor, a second hand-drawing image and second start information from said other communication terminal via said communication device; and
causing, by said processor, display of said second hand-drawing image from said point of time when input of said second hand-drawing image at said motion picture contents is started on said touch panel, based on said second start information.
